(19) United States
(12) Patent Application Publication
(10) Pub. No.: US 2006/0013299 A1
(43) Pub. Date: Jan. 19, 2006

(54) Coding apparatus, coding method, coding method program, and recording medium recording the coding method program

(75) Inventors: Kazushi Sato, Kanagawa (JP); Yiwen Zhu, Kanagawa (JP); Yoichi Yagasaki, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/155,687

(22) Filed: Jun. 20, 2005

(30) Foreign Application Priority Data
Jul. 7, 2004 (JP) P2004-200255

(51) Int. Cl. H04B 1/66; H04N 11/02; H04N 11/04; H04N 7/12

(52) U.S. Cl. 375/240.03; 375/240.18; 375/240.23; 375/240.12; 375/240.24

(57) ABSTRACT

Disclosed is an coding apparatus, an coding method, an coding method program, and a recording medium recording the coding method program. The present invention is applicable to transmission of motion pictures using satellite broadcasts, cable television, Internet, cellular phones, and the like, and recording of motion pictures on recording media such as optical disks, magnetic optical disks, flash memory, and the like, for example. In this manner, the coding apparatus can be also constructed to function as a decoding apparatus and an image conversion apparatus. An embodiment of the present invention can simplify the overall construction of such coding apparatus. An embodiment of the present invention detects an optimum prediction mode for intra prediction and inter prediction prior to a coding process. The embodiment detects variables IntraSAD, InterSAD, and (X) indicating differential data sizes according to the detected optimum prediction mode. The embodiment determines target code amounts for pictures according to the variables IntraSAD, InterSAD, and (X).

### CROSS REFERENCES TO RELATED APPLICATIONS

The present invention contains subject matter related to Japanese Patent Application JP 2004-200255 filed in the Japanese Patent Office on Jul. 7, 2004, the entire contents of which being incorporated herein by reference.

### BACKGROUND OF THE INVENTION

1. Field of the Invention

The present invention relates to a coding apparatus, a coding method, a coding method program, and a recording medium recording the coding method program. The present invention is applicable to transmission of motion pictures using satellite broadcasts, cable television, Internet, cellular phones, and the like, and recording of motion pictures on recording media such as optical disks, magnetic optical disks, flash memory, and the like, for example. The coding apparatus can detect an optimal prediction mode for intra prediction and inter prediction prior to a coding process. The coding apparatus can detect a variable indicating the differential data size according to the detected optimal prediction mode. Using the variable, the coding apparatus can set a target code amount for each picture. In this manner, the coding apparatus can be also constructed to function as a decoding apparatus and an image conversion apparatus. An embodiment of the present invention can simplify the overall construction of such coding apparatus.

2. Description of Related Art

Recently, there is a spreading use of apparatuses to efficiently transmit and store image data by effectively using image data redundancy for transmission and recording of motion pictures at broadcast stations, home, and the like. Such apparatuses are compliant with specific systems such as MPEG (Moving Picture Experts Group), for example. The apparatuses are constructed to compress image data using the orthogonal transformation such as the discrete cosine transform and the motion compensation.

As one of these systems, MPEG2 is defined as a general-purpose image coding system. The MPEG2 system is defined so as to be compliant with both the interlaced scan system and the progressive scan system and both standard resolution images and high resolution images. Presently, the MPEG2 system is widely used for a diverse range of applications from professionals to consumers. Specifically, for example, the MPEG2 compresses image data of 720×480 pixels at the standard resolution based on the interlaced scanning to a bit rate of 4 to 8 Mbps. The MPEG2 compresses image data of 1920×1088 pixels at the high resolution based on the interlaced scanning to a bit rate of 18 to 22 Mbps. The MPEG2 can ensure high image quality and high compression ratio.

However, the MPEG2 is a broadcast-oriented high quality coding system and is not compliant with coding systems at high compression ratios with less code amounts than MPEG1. As portable terminals are widely used in recent years, there is expected an increasing need for coding systems at high compression ratios with less code amounts than the MPEG1. According to such circumstances, the MPEG4-based coding standard was approved as an international standard in December, 1998, by ISO/IEC (International Organization for Standardization/International Electrotechnical Commission) 14496-2.

Such system promoted standardization of H26L (ITU-T Q6/16 VCEG) that initially aimed at image coding for teleconference. The system causes a more increased amount of computation but ensures higher coding efficiency than MPEG2 and MPEG4. As part of MPEG4 activities, various functions were incorporated based on the H26L. A coding system was proposed to ensure much higher coding efficiency. Standardization for such system was promoted as Joint Model of Enhanced-Compression Video Coding. In Mach, 2003, these systems were named H264 and MPEG-4 Part 10 (AVC: Advanced Video Coding) and were settled as international standards.

FIG. 3 is a block diagram showing an AVC-based coding apparatus. A coding apparatus 1 selects an optimum prediction mode from a plurality of intra prediction modes and inter prediction modes. The coding apparatus 1 subtracts a predictive value according to the prediction mode from video data to generate differential data. The coding apparatus 1 processes the differential data in terms of orthogonal transformation, quantization, and variable length coding. In this manner, the video data is subject to intra coding and inter coding.

In the coding apparatus 1, an analog/digital converter (A/D) 2 analog-digital converts a video signal S1 to output video data D1. A picture rearranging buffer 3 receives the video data D1 output from the analog/digital converter 2. The picture rearranging buffer 3 rearranges frames of the video data D1 for output according to the GOP (Group of Pictures) structure related to a coding process of the coding apparatus 1.

A subtractor 4 receives the video data D1 output from the picture rearranging buffer 3. During intracoding, the subtractor 4 generates and outputs differential data D2 between the video data D1 and a predictive value generated from an intra predictor 5. During inter coding, the subtractor 4 generates and outputs differential data D2 between the video data D1 and a predictive value generated from a motion predictor/compensator 6. An orthogonal transformer 7 receives the output data D2 from the subtractor 4. The orthogonal transformer 7 performs orthogonal transformation processes such as the discrete cosine transform, the Karhunen-Loeve transform, and the like. The orthogonal transformer 7 outputs transform coefficient data D3 as a process result.

A quantizer 8 uses a quantization scale under rate control of a rate controller 9 and quantizes and outputs the transform coefficient data D3. A lossless coding apparatus 10 processes the output data from the quantizer 8 according to lossless coding processes such as variable length coding, arithmetic coding, and the like, and outputs the processed data. Further, the lossless coding apparatus 10 obtains information about the intra prediction mode associated with the intracoding and information about motion vectors associated with the inter coding from the intra predictor 5 and the motion predictor/compensator 6. The lossless coding apparatus 10 allocates these pieces of information to header information in output data D4 and outputs it.

An accumulation buffer 11 accumulates the output data D4 from the lossless coding apparatus 10 and outputs the output data D4 at a transmission rate for the succeeding transmission path. The rate controller 9 monitors an unused capacity of the accumulation buffer 11 to monitor a generated code amount due to the coding process. According to a monitoring result, the rate controller 9 changes the quantization scale in the quantizer 8 to control the generated code amount from the coding apparatus 1.

An inverse quantizer 13 inversely quantizes the output data from the quantizer 8 to reproduce the input data to the quantizer 8. An inverse orthogonal transformer 14 processes output data from the inverse quantizer 13 according to inverse orthogonal transformation to reproduce the input data to the orthogonal transformer 7. A deblock filter 15 removes block distortion from the output data from the inverse orthogonal transformer 14 to output the data. The intra predictor 5 or the motion predictor/compensator 6 generates a predictive value. Where appropriate, frame memory 16 adds this predictive value to output data from the deblock filter 15 to record the data as reference image information.

During inter coding, the motion predictor/compensator 6 detects a motion vector for video data output from the picture rearranging buffer 3 based on a predictive frame according to the reference image information in the frame memory 16. Using the detected motion vector, the motion predictor/compensator 6 performs motion compensation for the reference image information in the frame memory 16 to generate the predictive image information. The motion predictor/compensator 6 outputs a predictive value based on the predictive image information to the subtractor 4.

During intra coding, the intra predictor 5 determines the intra prediction mode based on the reference image information accumulated in the frame memory 16. According to a determination result, the intra predictor 5 generates a predictive value for the predictive image information from the reference image information and outputs the predictive value to the subtractor 4.

In this manner, the coding system generates the differential data D2 according to the motion compensation associated with the inter prediction and the differential data D2 according to the intra prediction during the inter coding and the intra coding, respectively. The system is constructed to process these pieces of differential data D2 according to orthogonal transformation, quantization, and variable length coding and transmit them.

FIG. 4 is a block diagram showing a decoding apparatus to decode the coded data D4 after the above-mentioned coding process. In a decoding apparatus 20, an accumulation buffer 21 temporarily stores the coded data D4 that is input via the transmission path. A lossless decoding apparatus 22 decodes the output data from the accumulation buffer 21 according to the variable length decoding, arithmetic decoding, and the like. In this manner, the lossless decoding apparatus 22 reproduces the input data to the lossless coding apparatus 10 in the coding apparatus 1. When the output data is intra-coded, the lossless decoding apparatus 22 decodes the information about the intra prediction mode stored in the header to transmit the data to the intra predictor 23. When the output data is inter-coded, the lossless decoding apparatus 22 decodes the information about the motion vector stored in the header to transmit the data to the predictor/compensator 24.

An inverse quantizer 25 inversely quantizes the output data from the lossless decoding apparatus 22. In this manner, the inverse quantizer 25 reproduces the transform coefficient data D3 input to the quantizer 8 of the coding apparatus 1. An inverse orthogonal transformer 26 receives the transform coefficient data output from the inverse quantizer 25 and performs a quaternary inverse orthogonal transformation process. In this manner, the inverse orthogonal transformer 26 reproduces the differential data D2 input to the orthogonal transformer 7 of the coding apparatus 1.

An adder 27 receives the differential data D2 output from the inverse orthogonal transformer 26. During intra coding, the adder 27 adds the differential data D2 and a predictive value based on a predictive image generated from the intra predictor 23 and outputs a result. During inter coding, the adder 27 adds the differential data D2 and a predictive value based on a predictive image generated from the motion predictor/compensator 24 and outputs a result. In this manner, the adder 27 reproduces the input data to the subtractor 4 of the coding apparatus 1.

A deblock filter 28 removes block distortion from the output data from the adder 27 and outputs the data. A picture rearranging buffer 29 rearranges and outputs frames of the video data output from the deblock filter 28 according to the GOP structure. A digital/analog (D/A) converter 30 digital/analog converts the output data from the picture rearranging buffer 29 and outputs the data.

Frame memory 31 records and holds output data from the deblock filter 28 as the reference image information. During inter coding, a motion predictor/compensator 24 performs motion compensation for the reference image information held in the frame memory 31 based on the motion vector information notified from the lossless decoding apparatus 22. The motion predictor/compensator 24 generates a predictive value based on the predictive image and outputs the predictive value to the adder 27. During intracoding, an intra predictor 23 generates a predictive value from the reference image information held in the frame memory 31 based on the predictive image in the intra prediction mode notified from the lossless decoding apparatus 22. The intra predictor 23 outputs the predictive value to the adder 27.

The intra coding according to the above-mentioned coding process provides intra 4×4 prediction mode and intra 16×16 prediction mode. The AVC is constructed to perform the orthogonal transformation for the differential data D2 in units of blocks each composed of 4×4 pixels. The intra 4×4 prediction mode generates predictive values associated with the intra prediction in units of blocks for the orthogonal transformation process. On the other hand, the 16×16 prediction mode generates predictive values associated with the intra prediction in units of a plurality of blocks for the orthogonal transformation process. The plurality of blocks are composed of two blocks horizontally and two blocks vertically.

As shown in FIG. 5, the intra 4×4 prediction mode provides a block composed of 4×4 pixels a through p to generate predictive values. Part of 13 adjacent pixels A through M are used as predictive pixels to generate predictive values. The predictive pixel is used to generate a predictive value. The 13 pixels A through M are formed as follows. Four pixels A through D are vertically adjacent to a scan start edge of the block. Four pixels E through H are contiguous to the pixel D at a scan stop edge of the four pixels A through D. Four pixels I through L are horizontally adjacent to the scan start edge of the block. A pixel M is positioned above the pixel I at the scan start edge of the four horizontally adjacent pixels I through L.

The intra 4×4 prediction mode defines prediction modes 0 through 8 as shown in FIGS. 6 and 7 according to the relative relationship between the 13 pixels A through M and the 4×4 pixels a through p used to generate predictive values. As shown in FIG. 6, for example, modes 0 and 1 generate predictive values using pixels A through D and I through L vertically and horizontally adjacent to the 13 pixels A through Mused to generate predictive values.

More specifically, as depicted by arrows in FIG. 8 (A), mode 0 generates predictive values using the vertically adjacent pixels A through D. In this mode, a predictive pixel is assigned to pixel A above the first column of vertically contiguous pixels a, e, i, and m out of the 4×4 pixels a through p to generate predictive values. Further, a predictive pixel is assigned to pixel B above the second column of pixels b, f, j, and n. Predictive pixels are assigned to pixels C and D above the third column of pixels c, g, k, and o and the fourth column of pixels d, h, l, and p, respectively. Pixel values for the predictive pixels A through D are defined as predictive values for the pixels a through p. Mode 0 takes effect only when the predictive pixels A through D are significant in this mode.

As shown in FIG. 8(B), mode 1 generates predictive values using the horizontally adjacent pixels I through L. In this mode, a predictive pixel is assigned to pixel I to the left of the first row of horizontally contiguous pixels a through d out of the 4×4 pixels a through p to generate predictive values. A predictive pixel is assigned to pixel J to the left of the second row of horizontally contiguous pixels e through h. Predictive pixels are assigned to pixels K and L to the left of the third row of pixels i through k and the fourth row of pixels m through p, respectively. Pixel values for the predictive pixels I through L are defined as predictive values for the pixels a through p. Mode 1 takes effect only when the predictive pixels I through L are significant in this mode.

Mode 2, as shown in FIG. 8(C), generates predictive values using pixels A through D and I through L out of the 13 pixels A through M vertically and horizontally adjacent to the block. When all the pixels A through D and I through L are significant, the following equation can be used to generate predictive values for the pixels a through p.
(A+B+C+D+I+J+K+L+4)>> 3 [Equation 1]

In mode 2, when all the pixels A through D are insignificant, equation (2) is used to generate a predictive value. When all the pixels I through L are insignificant, equation (3) is used to generate a predictive value. When all the pixels A through D and I through L are insignificant, a predictive value is set to 128.
(I+J+K+L+2)>> 2 [Equation 2]
(A+B+C+D+2)>> 2 [Equation 3]

Mode 3, as shown in FIG. 8(D), generates predictive values using horizontally contiguous pixels A through H out of the 13 pixels A through M. Mode 3 takes effect only when all of the pixels A through D and I through M out of the pixels A through H are significant. The following equation is used to generate predictive values for the pixels a through p.

$$\begin{matrix} a \text{:} & ( A + 2 B + C + 2 ) ⪢ 2 \\ b , e \text{:} & ( B + 2 C + D + 2 ) ⪢ 2 \\ c , f , i \text{:} & ( C + 2 D + E + 2 ) ⪢ 2 \\ d , g , j , m \text{:} & ( D + 2 E + F + 2 ) ⪢ 2 \\ h , k , n \text{:} & ( E + 2 F + G + 2 ) ⪢ 2 \\ l , o \text{:} & ( F + 2 G + H + 2 ) ⪢ 2 \\ p \text{:} & ( G + 3 H + 2 ) ⪢ 2\end{matrix} \qquad \text{[Equation 4]}$$

Mode 4, as shown in FIG. 8(E), generates predictive values using the pixels A through D and I through M adjacent to the block of 4×4 pixels a through p out of the 13 pixels A through M. Mode 4 takes effect only when all of the pixels A through D and I through M are significant. The following equation is used to generate predictive values for the pixels a through p.

$$\begin{matrix} m \text{:} & ( J + 2 K + L + 2 ) ⪢ 2 \\ i , n \text{:} & ( I + 2 J + K + 2 ) ⪢ 2 \\ e , j , o \text{:} & ( M + 2 I + J + 2 ) ⪢ 2 \\ a , f , k , p \text{:} & ( A + 2 M + I + 2 ) ⪢ 2 \\ b , g , l \text{:} & ( M + 2 A + B + 2 ) ⪢ 2 \\ c , h \text{:} & ( A + 2 B + C + 2 ) ⪢ 2 \\ d \text{:} & ( B + 2 C + D + 2 ) ⪢ 2\end{matrix} \qquad [ Equation 5 ]$$

Mode 5, as shown in FIG. 8(F), is similar to mode 4 and generates predictive values using the pixels A through D and I through M adjacent to the block of 4×4 pixels a through p out of the 13 pixels A through M. Mode 5 takes effect only when all of the pixels A through D and I through M are significant. The following equation is used to generate predictive values for the pixels a through p.

$$\begin{matrix} a , j \text{:} & ( M + A + 1 ) ⪢ 1 \\ b , k \text{:} & ( A + B + 1 ) ⪢ 1 \\ c , l \text{:} & ( B + C + 1 ) ⪢ 1 \\ d \text{:} & ( C + D + 1 ) ⪢ 1 \\ e , n \text{:} & ( 1 + 2 M + A + 2 ) ⪢ 2 \\ f , o \text{:} & ( M + 2 A + B + 2 ) ⪢ 2 \\ g , p \text{:} & ( A + 2 B + C + 2 ) ⪢ 2 \\ h \text{:} & ( B + 2 C + D + 2 ) ⪢ 2 \\ i \text{:} & ( M + 2 I + J + 2 ) ⪢ 2 \\ m \text{:} & ( I + 2 J + K + 2 ) ⪢ 2\end{matrix} \qquad [ Equation 6 ]$$

Mode 6, as shown in FIG. 8(G), is similar to modes 4 and 5 and generates predictive values using the pixels A through D and I through M adjacent to the block of 4×4 pixels a through p out of the 13 pixels A through M. Mode 6 takes effect only when all of the pixels A through D and I through M are significant. The following equation is used to generate predictive values for the pixels a through p.

$$\begin{matrix} a , g \text{:} & ( M + I + 1 ) ⪢ 1 \\ b , h \text{:} & ( I + 2 M + A + 2 ) ⪢ 2 \\ c \text{:} & ( M + 2 A + B + 2 ) ⪢ 2 \\ d \text{:} & ( A + 2 B + C + 2 ) ⪢ 2 \\ e , k \text{:} & ( I + J + 1 ) ⪢ 1 \\ f , l \text{:} & ( M + 2 I + J + 2 ) ⪢ 2 \\ i , o \text{:} & ( J + K + 1 ) ⪢ 1 \\ j , p \text{:} & ( I + 2 J + K + 2 ) ⪢ 2 \\ m \text{:} & ( K + L + 1 ) ⪢ 1 \\ n \text{:} & ( J + 2 K + L + 2 ) ⪢ 2\end{matrix} \qquad [ Equation 7 ]$$

Mode 7, as shown in FIG. 8(H), generates predictive values using the four pixels A through D adjacent to the top of the block of 4×4 pixels a through p and three pixels E through G following the four pixels A through D. Mode 7 takes effect only when all of the pixels A through D and I through M are significant. The following equation is used to generate predictive values for the pixels a through p.

$$\begin{matrix} a \text{:} & ( A + B + 1 ) ⪢ 1 \\ b , i \text{:} & ( B + C + 1 ) ⪢ 1 \\ c , j \text{:} & ( C + D + 1 ) ⪢ 1 \\ d , k \text{:} & ( D + E + 1 ) ⪢ 1 \\ l \text{:} & ( E + F + 1 ) ⪢ 1 \\ o \text{:} & ( A + 2 B + C + 2 ) ⪢ 2 \\ f , m \text{:} & ( B + 2 C + D + 2 ) ⪢ 2 \\ g , n \text{:} & ( C + 2 D + E + 2 ) ⪢ 2 \\ h , o \text{:} & ( D + 2 E + F + 2 ) ⪢ 2 \\ p \text{:} & ( E + 2 F + G + 2 ) ⪢ 2\end{matrix} \qquad [ Equation 8 ]$$

Mode 8, as shown in FIG. 8(I), generates predictive values using the four pixels I through L adjacent to the left of the block of 4×4 pixels out of the 13 pixels A through M. Mode 8 takes effect only when all of the pixels A through D and I through M are significant. The following equation is used to generate predictive values for the pixels a through p.

$$\begin{matrix} a \text{:} & ( I + J + 1 ) ⪢ 1 \\ b \text{:} & ( I + 2 J + K + 2 ) ⪢ 2 \\ c , e \text{:} & ( J + K + 1 ) ⪢ 1 \\ d , f \text{:} & ( J + 2 K + L + 2 ) ⪢ 2 \\ g , i \text{:} & ( K + L + 1 ) ⪢ 1 \\ h , j \text{:} & ( K + 3 L + 2 ) ⪢ 2 \\ k , l , m , n , o , p \text{:} & L\end{matrix} \qquad [ Equation 9 ]$$

In the intra 16×16 prediction mode, as shown in FIG. 9, a block B is composed of 16×16 pixels P(0, 15) through P(15, 15) to generate predictive values. Predictive pixels are defined for the pixels P(0, 15) through P(15, 15) constituting the block and pixels P(0, −1) through P(15, −1) and P(−1, 0) through P(−1, 15) adjacent to the top and the left of the macro block MB. These predictive pixels are used to generate predictive values.

As shown in FIG. 10, the intra 16×16 prediction mode defines prediction modes 0 through 3. Of these, mode 0 takes effect only when pixels P(0, −1) through P(15, −1) (assuming x or y to be −1 through 15 in P(x, −1)) adjacent to the top of a macro block MB are significant. The following equation is used to generate predictive values for the pixels P(0, 15) through P(15, 15) constituting the block B. As shown in FIG. 11(A), pixel values for the pixels P(0, −1) through P(15, −1) adjacent to the block B are used to generate predictive values for the contiguous pixels in the vertical direction of the block B.
Pred (x, y)=P (x, −1); x, y=0.15 [Equation 10]

Mode 1 takes effect only when pixels P(−1, 0) through P(−1, 15) (assuming x or y to be −1 through 15 in P(−1, y)) adjacent to the left of the block B are significant. The following equation is used to generate predictive values for the pixels P(0, 15) through P(15, 15) constituting the block B. As shown in FIG. 11(B), pixel values for the pixels P (−1, 0) through P (−1, 15) adjacent to the block B are used to generate predictive values for the contiguous pixels in the horizontal direction of the block B.
Pred (x, y)=P (−1, y); x, y=0.15 [Equation 11]

Mode 2 takes effect when all of the pixels P(0, −1) through P(15, −1) and P(−1, 0) through P(−1, 15) adjacent to the top and the left of the block B are significant. The following equation is used to find predictive values. As shown in FIG. 11(C), an average of the pixel values for the pixels P (0, −1) through p (15, −1) and P (−1, 0) through P (−1, 15) is used to generate predictive values for the pixels constituting the block B.

$$Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] ⪢ 5 \\ with x , y = 0 … 15 \qquad [ Equation 12 ]$$

In mode 2, there may be a case where the pixels P(−1, 0) through P(−1, 15) are insignificant out of the pixels P(0, −1) through P(15, −1) and P(−1, 0) through P(−1, 15) adjacent to the top and the left of the block B. In this case, equation (13) is used to generate predictive values for the pixels according to an average value for the adjacent pixels at the significant side. When the pixels P(−1, 0) through P(−1, 15) adjacent to the left are insignificant, equation (14) is used. Also in this case, an average value for the adjacent pixels at the significant side is used to generate predictive values for the pixels constituting the block B. When none of the pixels P(0, −1) through P(15, −1) and P(−1, 0) through P(−1, 15) adjacent to the top and the left of the block B is significant, a predictive value is set to 128.

$$\begin{matrix}Pred ( x , y ) = [ {\sum }_{{y}^{′} = 0}^{15} P ( - 1 , {y}^{′} ) + 8 ] ⪢ 4 \\ with x , y = 0 … 15 & [ Equation 13 ] \\ Pred ( x , y ) = [ {\sum }_{{x}^{′} = 0}^{15} P ( {x}^{′} , - 1 ) + 8 ] ⪢ 4 \\ with x , y = 0 … 15. & [ Equation 14 ]\end{matrix}$$

Mode 3 takes effect only when all the pixels P(0, −1) through P(15, −1) and the P(−1, 0) through P(−1, 15) adjacent to the top and the left of the block B are significant. The following equation is used to generate predictive values. As shown in FIG. 11(D), a diagonal operation process is used to generate predictive values for the pixels.

$$Pred ( x , y ) = Clip 1 ( ( a + b \cdot ( x - 7 ) + c \cdot ( y - 7 ) + 16 ) ⪢ 5 ) \\ a = 16 \cdot ( P ( - 1 , 15 ) + P ( 15 , - 1 ) ) \\ b = ( 5 \cdot H + 32 ) ⪢ 6 \\ c = ( 5 \cdot V + 32 ) ⪢ 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) \qquad [ Equation 15 ]$$

In this manner, the intra predictor 5 of the coding apparatus 1 inputs the video data D1 output from the picture rearranging buffer 3 for I, P, and B pictures. The intra predictor 5 performs so-called intra prediction to select an optimum prediction mode according to the reference image information held in the frame memory 16. For intra coding in the selected prediction mode, the intra predictor 5 generates a predictive value in the selected prediction mode according to the reference image information and outputs the predictive value to the subtractor 4. The intra predictor 5 notifies the prediction mode to the lossless coding apparatus 10 to transmit the prediction mode along with the coded data D4. By contrast, the intra predictor 23 of the decoding apparatus 20 calculates a predictive value according to the information in the prediction mode transmitted with the coded data D4 and outputs the calculated value to the adder 27.

As shown in FIG. 12, the inter coding uses multiple reference frames. Any of the reference frames Ref is selected for frame Org to be processed so that the motion compensation is feasible. There may be a case where a portion corresponding to the block for the motion compensation is hidden in an immediately preceding frame. There may be another case where a flash temporarily changed the entire pixel values for the immediately preceding frame. In these cases, the high-precision motion compensation can improve the data compression efficiency.

As shown in FIG. 13 (A1), the motion compensation is applied to blocks with reference to a block of 16×16 pixels. Further, the tree-structured motion compensation is supported according to the variable MC Block Size. Accordingly, as shown in FIGS. 13(A2) through 13(A4), a block of 16×16 pixels can be halved horizontally or vertically to provide sub-macro blocks of 16×8, 8×16, and 8×8 pixels. The sub-macro blocks are provided with motion vectors and reference frames independently of each other to be capable of the motion compensation. As shown in FIGS. 13(B1) through 13(B4), a sub-macro block of 8×8 pixels is further divided into blocks of 8×8, 8×4, 4×8, and 4×4 pixels. These blocks are provided with motion vectors and reference frames independently of each other to be capable of the motion compensation. In the description to follow, the largest basic block of 16×16 pixels is referred to as a macro block in terms of the motion compensation.

The motion compensation uses a 6-tap FIR filter to provide the motion compensation at the ¼-pixel accuracy. In FIG. 14, code A indicates a pixel value at the 1-pixel accuracy. Codes b through d indicate pixel values at the ½-pixel accuracy. Codes e1 through e3 indicate pixel values at the ¼-pixel accuracy. In this case, the following calculation is first performed by weighting tap inputs for the 6-tap FIR filter with values 1, −5, 20, 20, −5, and 1. In this manner, pixel value b or d is calculated at the ½-pixel accuracy between horizontally or vertically contiguous pixels.
F=A₋₂−5·A₋₁+20·A₀+20·A₁−5·A₂+A₃b.d=Clip1 ((F+16)>>5) [Equation 16]

The calculated pixel value b or d at the ½-accuracy is used to perform the following calculation by weighting tap inputs for the 6-tap FIR filter with values 1, −5, 20, 20, −5, and 1. In this manner, pixel value c is calculated at the ½-pixel accuracy between horizontally and vertically contiguous pixels.
F=b₋₂−5·b₋₁+20·b₀+20·b₁−5·b₂+b₃ [Equation 17]

or
F=d₋₂−5·d₋₁+20·d₀+20·d₋₁−5·d₂+d₃c=Clip1 ((F+512)>>10)

The calculated pixel values b through d at the ½-accuracy are used to perform the following calculation based on the linear interpolation and calculate the pixels e1 through e3 at the ¼-pixel accuracy. The normalization process for weighting in the equations (16) and (17) is performed after completion of all vertical and horizontal interpolation processes.
e₁=(A+b+1)>> 1
e₂=(b+d+1)>> 1
e₃=(b+c+1)>> 1 [Equation 18]

In this manner, the motion predictor/compensator 6 of the coding apparatus 1 detects motion vectors at the ¼-pixel accuracy according to the macro block and sub-macro blocks in P and B pictures using a plurality of prediction frames. A prediction frame is defined by a coding process level and a profile according to the reference image information held in the frame memory 16. The motion predictor/compensator 6 detects a motion vector according to a reference frame and a block having the smallest prediction error. The motion predictor/compensator 6 uses the reference frame and the block, when detected in this manner, to perform the motion compensation at the ¼-pixel accuracy for the reference image information held in the frame memory 16 and to perform a so-called inter prediction process. When using the inter prediction for the inter coding process, the motion predictor/compensator 6 outputs a pixel value according to the motion compensation as a predictive value to the subtractor 4. The motion predictor/compensator 6 notifies the lossless coding apparatus 10 of the reference frame, the block, and the motion vector and transmits them along with the coded data D4. On the other hand, the motion predictor/compensator 24 of the decoding apparatus 20 uses the reference frame, the block, and the motion vector transmitted with the coded data D4 to perform the motion compensation at the ¼-pixel accuracy for the reference image information held in the frame memory 16 and generate a predictive value. The motion predictor/compensator 24 outputs this predictive value to the adder 27. In terms of P and B pictures, the coding apparatus 1 selects intra coding or inter coding based on an intra prediction result according to the intra predictor 5 and an inter prediction result according to the motion predictor/compensator 6. According to the selection result, the intra predictor 5 and the motion predictor/compensator 6 output predictive values according to the intra prediction and the inter prediction, respectively.

By contrast, the rate controller 9 provides rate control using the technique according to TM5 (MPEG-2 Test Model 5), for example. The TM5-based rate control technique controls the quantization scale of the quantizer 8 by performing a process in FIG. 15. When starting the process, the rate controller 9 moves from Step SP1 to Step SP2. The rate controller 9 calculates target code amounts for uncoded pictures out of those constituting one GOP to distribute bits to the pictures. The TM5 calculates a code allocation amount for each picture based on the following two assumptions.

A first assumption is that each picture type has a constant product between an average quantization scale used to encode pictures and the generated code amount unless the picture changes. Based on this, the rate control encodes the pictures, and then updates parameters Xᵢ, Xₚ, and X_{b} (global complexity measures) to represent the picture complexity for each picture type using the following equation. Using these parameters Xᵢ, Xₚ, and X_{b}, the TM5-based rate control estimates the relationship between the quantization scale and the generated code amount for encoding the next picture.
Xᵢ=SᵢQᵢ
Xₚ=SₚQₚ
X_{b}=S_{b}Q_{b} [Equation 19]

In equation (19), the variables' subscripts denote I, P, and B pictures. Sᵢ, Sₚ, and S_{b} denote generated code bit amounts according to the coding processes for the pictures. Qᵢ, Qₚ, and Q_{b} denote average quantization scale codes for encoding the pictures. The following equation provides initial values for the parameters Xᵢ, Xₚ, and X_{b} using target code amount bit rates (bits/sec).
Xᵢ=160×bit_rate/115
Xₚ=60bit_rate/115
X_{b}=42×bit_rate/115 [Equation 20]

A second assumption is that the overall image quality is always best when the following equation maintains the relationship between Kₚ and K_{b}, where Kₚ is a ratio of the P picture's quantization scale code to the I picture's quantization scale and K_{b} is a ratio of the B picture's quantization scale code to the I picture's quantization scale.
Kₚ=1.0; K_{b}=1.4 [Equation 21]

That is, this assumption signifies that the overall image quality is kept to be best by setting the B picture's quantization scale always 1.4 times the I or P picture's quantization scale. B pictures are more coarsely quantized than I and P pictures to economize code amounts allocated to B pictures. Compensatingly, more code amounts are allocated to I and P pictures to improve the image quality of these pictures. In addition, this improves the image quality of B pictures to reference I and P pictures. As a result; the overall image quality is assumed to be best.

In this manner, the rate controller 9 uses the calculation according to the following equation to compute bit amounts Tᵢ, Tₚ, and T_{b} allocated to the pictures. In the following equation, Nₚ or N_{b} each denotes the number of P or B pictures that are not coded in the GOP to be processed.

$${T}_{i} = max \{ \frac{R}{1 + \frac{{N}_{p} {X}_{p}}{{X}_{i} {K}_{p}} + \frac{{N}_{b} {X}_{b}}{{X}_{i} {K}_{b}}} , bit\_rate / ( 8 \times picture\_rate ) \} \\ {T}_{p} = max \{ \frac{R}{{N}_{p} + \frac{{N}_{b} {K}_{p} {X}_{b}}{{K}_{b} {X}_{p}}} , bit\_rate / ( 8 \times picture\_rate ) \} \\ {T}_{b} = max \{ \frac{R}{{N}_{b} + \frac{{N}_{p} {K}_{b} {X}_{p}}{{K}_{p} {X}_{b}}} , bit\_rate / ( 8 \times picture\_rate ) \} . \qquad [ Equation 22 ]$$

Based on the above-mentioned two assumptions, the rate controller 9 estimates generated code amounts for the pictures. When a picture has the picture type different from that targeted for the code allocation, the rate controller 9 estimates what times the generated code amount of the picture targeted for the allocation is the code amount generated by the picture under an image quality optimization condition. Based on this assumption, the rate controller 9 estimates the correspondence between uncoded pictures in the GOP and the equivalent number of pictures having the picture type targeted for the code allocation. Based on this estimation result, the rate controller 9 calculates the bit amount allocated to each picture. When calculating the bit amount to be allocated, the rate controller 9 sets the lower bound to a value in consideration for a constantly needed code amount such as the header and the like.

The TM5-based rate control then proceeds to Step SP3 to perform a rate control process using virtual buffer control. The rate control process provides three types of independent virtual buffers corresponding to the picture types so as to ensure correspondence between bit amounts Tᵢ, Tₚ, and T_{b} found at Step SP2 for allocation to the pictures and the actually generated code amounts. Based on capacities of the virtual buffers the process calculates the quantization scale of the quantizer 8 under feedback control in units of macro blocks.

The following equation is used to first calculate the occupancy of the three types of virtual buffers. In the equation, dₒⁱ, dₒ^{p}, and dₒ^{b} denote initial occupation amounts of the virtual buffers; Bⱼ denotes the generated bit amount from the beginning of a picture to the jth macro block; and MB_cnt denotes the number of macro blocks in one picture.

$${d}_{j}^{i} = {d}_{0}^{i} + {B}_{j - 1} - \frac{{T}_{i} \times ( j - 1 )}{MB\_cnt} \\ {d}_{i}^{p} = {d}_{0}^{p} + {B}_{j - 1} - \frac{{T}_{p} \times ( j - 1 )}{MB\_cnt} \\ {d}_{i}^{b} = {d}_{0}^{b} + {B}_{j - 1} - \frac{{T}_{b} \times ( j - 1 )}{MB\_cnt} \qquad [ Equation 23 ]$$

Based on a calculation result from equation (23), the process uses the following equation to calculate a quantization scale for the jth macro block.

$${Q}_{j} = \frac{{d}_{j} \times 31}{r} \qquad [ Equation 24 ]$$

In the equation, r denotes a reaction parameter to control a feedback response. According to TM5, the following equation is used to supply reaction parameter r and initial values dₒⁱ, dₒ^{p}, and dₒ^{b}.

$$r = \frac{2 \times bit\_rate}{picture\_rate} \\ {d}_{0}^{i} = 10 \times r / 31 ; {d}_{0}^{p} = {K}_{p} {d}_{0}^{i} ; {d}_{0}^{b} = {K}_{b} {d}_{0}^{i} \qquad [ Equation 25 ]$$

The TM5 rate control proceeds to Step SP4 to correct the quantization scale found at Step SP3 in consideration for visual characteristics. This performs the optimum quantization in consideration for visual characteristics. The optimum quantization process is performed by correcting the quantization scale found at Step SP3 according to activities of macro blocks. The purpose is to more finely quantize a flat portion where visual deterioration is easily noticeable, or to more coarsely quantize a complex pattern where visual deterioration is relatively hardly noticeable.

An activity is calculated by the following equation for each macro block of 16×16 pixels with respect to four blocks each composed of 8×8 pixels constituting the macro block. The calculation uses pixels for a total of eight blocks, i.e., four blocks in frame DCT mode and four blocks in field DCT mode. This indicates the smoothness of brightness level for the macro block.

$${act}_{j} = 1 + min {( var\_sblk )}_{sblk = 1.8} \\ var\_sblk = \frac{1}{64} {\sum }_{k = 1}^{64} {( {P}_{k} - \overline{P} )}^{2} \\ \overline{P} = \frac{1}{64} {\sum }_{k = 1}^{64} {P}_{k} \qquad [ Equation 26 ]$$

In this equation, Pₖ denotes a pixel value in a brightness signal block on an original picture. Equation (26) uses a minimum value for the purpose of preventing the image quality from deteriorating by providing fine steps when only part of the macro block contains a flat portion.

After finding an activity using this equation, the rate controller 9 normalizes the activity using the following equation to find normalization activity Nactⱼ whose values range from 0.5 to 2. In the equation, avg_act denotes an average of activities actⱼ in a most recently coded picture.

$${Nact}_{j} = \frac{2 \times {act}_{j} + avg\_act}{{act}_{i} + 2 \times avg\_act} \qquad [ Equation 27 ]$$

The rate controller 9 uses the normalization activity Nactⱼ to perform the calculation of the following equation and corrects quantization scale Qⱼ calculated at Step SP3 to control the quantizer 8.
mquantᵢ=Qᵢ×Nactⱼ [Equation 28]

Based on the above-mentioned two assumptions, the TM5-based rate control distributes the code amount to the pictures and the macro blocks. The feedback control is provided to sequentially correct the distributed code amounts using the actual generated code amounts. In this manner, the quantization scale is controlled to be coded sequentially.

However, such feedback-based rate control provides the code amount control using characteristics of already coded frames. Accordingly, the image quality stability may be hindered. Constant values are assigned to the quantization scale ratios for the I, P, and B pictures as targets. The ratios are subject to different optimum values depending on sequences.

The optimum rate control will be described below on the assumption that the feed-forward control is available. Let us assume that the following equation provides the relationship between distortion D and the quantization scale.
D=a Q^{m} [Equation 29]

The following equation defines cost function F. In the equation, N denotes the number of frames included in the GOP and is defined as 1≦i≦N.

$$F = \frac{1}{N} {\sum }_{i} {D}_{i} \qquad [ Equation 30 ]$$

The cost function F is solved under the restrictive condition of the following equation, assuming R to be the code allocation amount for all the uncoded frames. It is possible to calculate optimum allocation code amount Rᵢ.

$$R = {\sum }_{i} {R}_{i} \qquad [ Equation 31 ]$$

Generally, this calculation can be solved by the following equation using the Lagrange multiplier method.

$$\begin{matrix}φ = F - λ ( R - \sum {R}_{i} ) \\ = \frac{a}{N} {\sum }_{i} {g ( {R}_{i} )}^{m} - λ ( R - {\sum }_{i} {R}_{i} ) \\ = \frac{a}{N} {\sum }_{i} {Q}_{i}^{m} - λ ( R - {\sum }_{i} f ( {Q}_{i} ) )\end{matrix} \qquad [ Equation 32 ]$$

When R=f(Q) and Q=g(R), the cost function F results in a minimum value under the following condition.

$$\frac{\partial φ}{\partial {R}_{1}} = \frac{\partial φ}{\partial {R}_{2}} = … = \frac{\partial φ}{\partial {R}_{1}} = … = 0 or \\ \frac{\partial φ}{\partial {Q}_{1}} = \frac{\partial φ}{\partial {Q}_{2}} = … = \frac{\partial φ}{\partial {Q}_{1}} = … = 0 \\ \frac{\partial φ}{\partial {R}_{1}} = \frac{a \cdot m}{N} \frac{\partial g}{\partial {R}_{1}} {g ( {R}_{1} )}^{m - 1} + λ = 0 \qquad [ Equation 33 ]$$

In this manner, optimum allocation code amount Rᵢ can be found by solving these simultaneous equations. The following equation expresses complexity parameter X in the MPEG2 TM5. Consequently, the relation in equation (35)is established between quantization scale Q and code amount R.
Q·R^{α}=X [Equation 34]
log R=a·log Q+b [Equation 35]

In the equation, α is a parameter to determine the quantization characteristic (Rate-Quantization characteristic) in the quantizer 8. Assuming that α is a fixed value, equation (32) can be expressed by the following equation. Solving this equation can yield equation (37).

$$\begin{matrix}\begin{matrix}φ = \frac{a}{N} {\sum }_{i} {( \frac{{X}_{i}}{{R}_{i}^{α}} )}^{m} - λ ( R - {\sum }_{i} {R}_{i} ) \\ = \frac{a}{N} {\sum }_{i} {X}_{i}^{m} \cdot {R}_{i}^{- α m} - λ ( R - {\sum }_{i} {R}_{i} )\end{matrix} \\ \frac{\partial φ}{\partial {R}_{i}} = - \frac{a α m}{N} {X}_{i}^{m} \cdot {R}_{i}^{- ( 1 + α m )} + λ = 0 \\ {R}_{i} = {( \frac{a α m}{N λ} {X}_{i}^{m} )}^{\frac{1}{1 + α m}} \\ R = {\sum }_{i} {R}_{i} = {\sum }_{i} {( \frac{a α m}{N λ} {X}_{i}^{m} )}^{\frac{1}{1 + α m}} \\ {λ}^{\frac{1}{1 + α m}} = \frac{1}{R} {\sum }_{i} {( \frac{a α m}{N} \cdot {X}_{i}^{m} )}^{\frac{1}{1 + α m}} & [ Equation 36 ] \\ {R}_{i} = R \cdot \frac{{X}_{i}^{\frac{m}{1 + α m}}}{{\sum }_{i} {X}_{i}^{\frac{m}{1 + α m}}} \\ {Q}_{i} = \frac{{X}_{i}^{\frac{m}{1 + α m}}}{{R}^{α} \{ {\sum }_{i} {X}_{i}^{\frac{m}{1 + α m}} \}} & [ Equation 37 ]\end{matrix}$$

Equation (37) provides a solution that generalizes the code amount allocation by MPEG2 TM5. Assuming that the respective picture types maintain the constant quantization characteristic, assigning the equation to the following equation can arrive at the relational expression in equation (21). In this manner, the TM5-based rate control uses fixed values of 1.0 and 1.4 for ratios Kₚ and K_{b}. However, it is possible to more appropriately allocate code amounts by previously detecting the complexity parameter X according to the feed-forward control.

$$α = 1 ; {K}_{p} = {( \frac{{X}_{1}}{{X}_{P}} )}^{\frac{1}{m + 1}} ; {K}_{b} = {( \frac{{X}_{1}}{{X}_{B}} )}^{\frac{1}{m + 1}} \qquad [ Equation 38 ]$$

In terms of such coding apparatus, for example, JP-A No. 56827/2004 proposes various contrivances for facilitating the decoding process and the like.

The coding apparatus 1 may process not only baseband-supplied video data in combination with various recording apparatuses, but also video data supplied from network media and package media. Such network media and package media use MPEG2 and the like to compress video data. When processing such video data, the coding apparatus functions as not only a decoding apparatus to decode the compressed video data, but also an image conversion apparatus to convert the data compression format.

When the coding apparatus is constructed to function as a decoding apparatus and an image conversion apparatus, it is obviously desirable to simplify the overall construction.

[Patent document 1]JP-A No. 56827/2004

### SUMMARY OF THE INVENTION

The present invention has been made in consideration of the foregoing. There is a need for constructing a coding apparatus to function as a decoding apparatus and an image conversion apparatus. In such case, it is desirable to provide a coding apparatus, a coding method, a coding method program, and a recording medium recording the coding method program capable of simplifying the overall construction.

To solve the above-mentioned problem, an embodiment of the present invention is applied to a coding apparatus which uses coding means to select an optimum prediction mode out of a plurality of intra prediction modes and inter prediction modes, generate differential data by subtracting a predictive value according to the selected prediction mode from video data, perform orthogonal transformation, quantization, and variable length coding processes for the differential data, and encode the video data according to intra coding and inter coding. The embodiment according to the present invention provides: intra prediction means for selecting an optimum prediction mode using the video data in advance for at least one GOP prior to coding by the coding means and detecting an intra prediction variable indicating a size of differential data in the optimum prediction mode; inter prediction means for selecting an optimum prediction mode using the video data in advance for at least one GOP prior to coding by the coding means and detecting an inter prediction variable indicating a size of differential data in the optimum prediction mode; difficulty calculation means for comparing a variable for the intra prediction with a variable for the inter prediction and detecting a variable indicating a size of differential data in an optimum prediction mode; and rate control means for distributing a data amount to be allocated to one GOP among pictures based on a variable indicating a size of the differential data to calculate a target code amount of each picture and providing rate control for a coding process by the coding means based on the target code amount.

Another embodiment of the present invention is applied to a coding method which uses coding means to select an optimum prediction mode out of a plurality of intra prediction modes and inter prediction modes, generate differential data by subtracting a predictive value according to the selected prediction mode from video data, perform orthogonal transformation, quantization, and variable length coding processes for the differential data, and encode the video data according to intra coding and intercoding. The embodiment according to the present invention includes the steps of: selecting an optimum prediction mode using the video data in advance for at least one GOP prior to coding by the coding means and detecting an intra prediction variable indicating a size of differential data in the optimum prediction mode; selecting an optimum prediction mode using the video data in advance for at least one GOP prior to coding by the coding means and detecting an inter prediction variable indicating a size of differential data in the optimum prediction mode; comparing a variable for the intra prediction with a variable for the inter prediction and detecting a variable indicating a size of differential data in an optimum prediction mode; and distributing a data amount to be allocated to one GOP among pictures based on a variable indicating a size of the differential data to calculate a target code amount of each picture and providing rate control for a coding process by the coding means based on the target code amount.

Still another embodiment of the present invention is applied to a coding method program performed by calculation means to control operations of coding means. The coding method program includes the steps of: selecting an optimum prediction mode using the video data in advance for at least one GOP prior to coding by the coding means and detecting an intra prediction variable indicating a size of differential data in the optimum prediction mode; selecting an optimum prediction mode using the video data in advance for at least one GOP prior to coding by the coding means and detecting an inter prediction variable indicating a size of differential data in the optimum prediction mode; comparing a variable for the intra prediction with a variable for the inter prediction and detecting a variable indicating a size of differential data in an optimum prediction mode; and distributing a data amount to be allocated to one GOP among pictures based on a variable indicating a size of the differential data to calculate a target code amount of each picture and providing rate control for a coding process by the coding means based on the target code amount.

Yet another embodiment of the present invention is applied to a recording medium for recording a coding method program performed by calculation means to control operations of coding means. The coding method program includes the steps of: selecting an optimum prediction mode using the video data in advance for at least one GOP prior to coding by the coding means and detecting an intra prediction variable indicating a size of differential data in the optimum prediction mode; selecting an optimum prediction mode using the video data in advance for at least one GOP prior to coding by the coding means and detecting an inter prediction variable indicating a size of differential data in the optimum prediction mode; comparing a variable for the intra prediction with a variable for the inter prediction and detecting a variable indicating a size of differential data in an optimum prediction mode; and distributing a data amount to be allocated to one GOP among pictures based on a variable indicating a size of the differential data to calculate a target code amount of each picture and providing rate control for a coding process by the coding means based on the target code amount.

The construction of the embodiment may be applied to a coding apparatus so as to include intra prediction means for selecting an optimum prediction mode using the video data in advance for at least one GOP prior to coding by the coding means and detecting an intra prediction variable indicating a size of differential data in the optimum prediction mode; inter prediction means for selecting an optimum prediction mode using the video data in advance for at least one GOP prior to coding by the coding means and detecting an inter prediction variable indicating a size of differential data in the optimum prediction mode; difficulty calculation means for comparing a variable for the intra prediction with a variable for the inter prediction and detecting a variable indicating a size of differential data in an optimum prediction mode; and rate control means for distributing a data amount to be allocated to one GOP among pictures based on a variable indicating a size of the differential data to calculate a target code amount of each picture and providing rate control for a coding process by the coding means based on the target code amount. There may be a case of constructing the coding apparatus so as to function as a decoding apparatus and an image conversion apparatus. In such case, a variable indicating the differential data size may be replaced by a multiplied value between a quantization scale for each picture obtained by the decoding apparatus and a code amount, for example. This makes it possible to provide rate control by effectively using various information detected in decoding processes. In this manner, the construction can be simplified to ensure the function as the image conversion apparatus.

When there is a need for configuring a coding apparatus to function as a decoding apparatus and an image conversion apparatus, the above-mentioned embodiments can provide a coding method, a coding method program, and a recording medium recording the coding method program capable of simplifying the overall construction.

According to the embodiments of the present invention, the overall construction can be simplified when the coding apparatus may be configured to function as a decoding apparatus and an image conversion apparatus.

Other and further objects, features and advantages of the invention will appear more fully from the following description.

### BRIEF DESCRIPTION OF THE DRAWINGS

FIG. 1 is a block diagram showing a coding apparatus according to embodiment 1 of the present invention;

FIG. 2 is a flowchart showing a process of a rate controller 9 in the coding apparatus in FIG. 1;

FIG. 3 is a block diagram showing an AVC-based coding apparatus;

FIG. 4 is a block diagram showing an AVC-based decoding apparatus;

FIG. 5 is a diagram showing prediction pixels concerning intra 4×4 prediction mode;

FIG. 6 is a diagram showing a prediction mode in the intra 4×4 prediction mode;

FIG. 7 is a diagram describing the intra 4×4 prediction mode;

FIG. 8 is a diagram showing each mode of the intra 4×4 prediction mode;

FIG. 9 is a diagram showing prediction pixels concerning intra 16×16 prediction mode;

FIG. 10 is a diagram describing the intra 16×16 prediction mode;

FIG. 11 is a diagram showing a prediction mode in the intra 16×16 prediction mode;

FIG. 12 is a diagram showing an AVC-based reference frame;

FIG. 13 is a diagram showing an AVC-based motion compensation;

FIG. 14 is a diagram showing AVC-based motion compensation accuracy; and

FIG. 15 is a flowchart showing TM5-based rate control.

### DETAILED DESCRIPTION OF THE PREFERRED EMBODIMENTS

Embodiments of the present invention will be described in further detail with reference to the accompanying drawings.

[Embodiment 1]

(1) Construction of the Embodiment

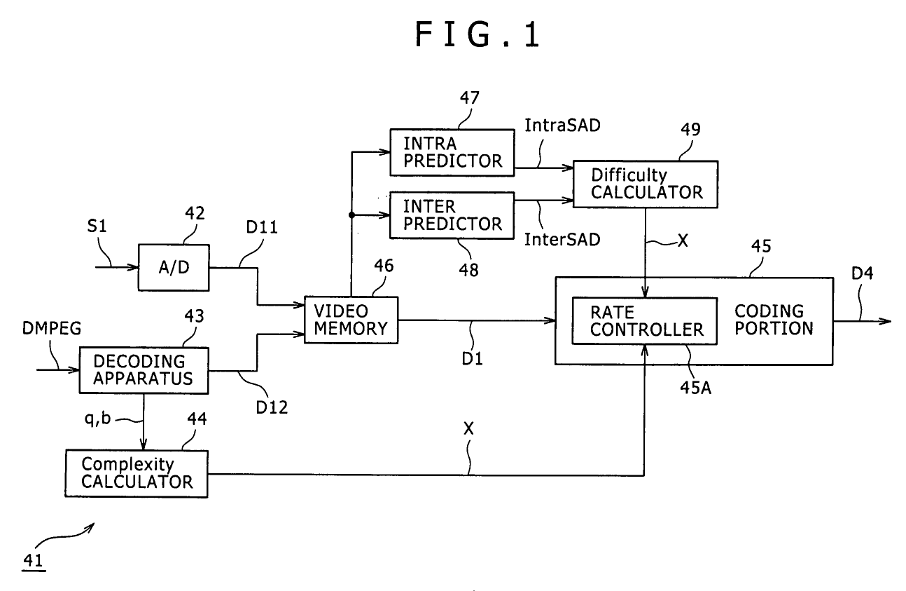

FIG. 1 is a block diagram showing a coding apparatus according to an embodiment of the present invention. For example, a DVD player or the like reproduces MPEG2 compressed coding data DMPEG. A television tuner outputs analog video signal S1. A recording and reproducing apparatus records the coded data DMPEG and the video signal S1 on recording media such as optical disks. A coding apparatus 41 is applicable to such recording and reproducing apparatus, compresses the coded data DMPEG and the video signal S1 based on the AVC, and outputs coded data D4.

In the coding apparatus 41, an A/D converter (A/D) 42 analog-digital converts the video signal S1 and outputs video data D11.

The decoding apparatus 43 is supplied with MPEG2-based coded data DMPEG, decodes the coded data DMPEG, and outputs baseband-based video data D12. In this process, the decoding apparatus 43 notifies a complexity calculator 44 of quantization scale Q and generated code amount B that are detected by a control code provided for each header of the coded data DMPEG.

In response to the notification from the decoding apparatus 43, the complexity calculator 44 calculates average quantization scale Q of frames in the coded data DMPEG and calculates generated code amount B for each frame. The complexity calculator 44 performs the following calculation using the average quantization scale Q and the generated code amount B. The complexity calculator 44 calculates complexity parameter X indicating the difficulty of AVC coding for the video data D12 obtained by decoding the coded data DMPEG and notifies a coding portion 45 of the complexity parameter X.
X=Q·B [Equation 39]

An A/D converter 42 outputs video data D11 under control of a controller (not shown). A decoding apparatus 43 outputs video data D12. Video memory 46 is selectively supplied with the video data D11 or D12, stores it for a specified period, and outputs it to the coding portion 45. In this process, the video memory 46 outputs the stored video data to an intra predictor 47 and an inter predictor 48 at a time point prior to the video data output to the decoding apparatus 43 for a period equivalent to at least one GOP. This enables the intra predictor 47 and the inter predictor 48 to process the video data for one GOP before the coding by the decoding apparatus 43. The video data D12 output from the decoding apparatus 43 may be input to the video memory 46 and is output to the coding portion 45. In this case, the one-GOP period for the preceding output is adjusted to the one-GOP period for coded data DMPEG associated with the video data D12.

The intra predictor 47 performs intra prediction for video data supplied from the video memory 46. The original intra prediction is performed with reference to the decoded reference image information. The intra predictor 47 performs the intra prediction using original image's image information instead of the decoded reference image information. The original intra prediction selects the optimum prediction mode between the intra 4×4 prediction mode and the intra 16×16 prediction mode. The intra prediction 47 uses only the intra 4×4 prediction mode to select the optimum prediction mode.

With respect to a block of 4×4 pixels in the sequentially input video data, the following equation is used to express pixel values for the video data according to the original image constituting the block.

$$[ {Org}_{i , j} ] = [ \begin{matrix}{Org}_{0 , 0} & {Org}_{1 , 0} & {Org}_{2 , 0} & {Org}_{3 , 0} \\ {Org}_{0 , 1} & {Org}_{1 , 1} & {Org}_{2 , 1} & {Org}_{3 , 3} \\ {Org}_{0 , 2} & {Org}_{1 , 2} & {Org}_{2 , 2} & {Org}_{3 , 3} \\ {Org}_{0 , 3} & {Org}_{1 , 3} & {Org}_{2 , 3} & {Org}_{3 , 3}\end{matrix} ] \qquad [ Equation 40 ]$$

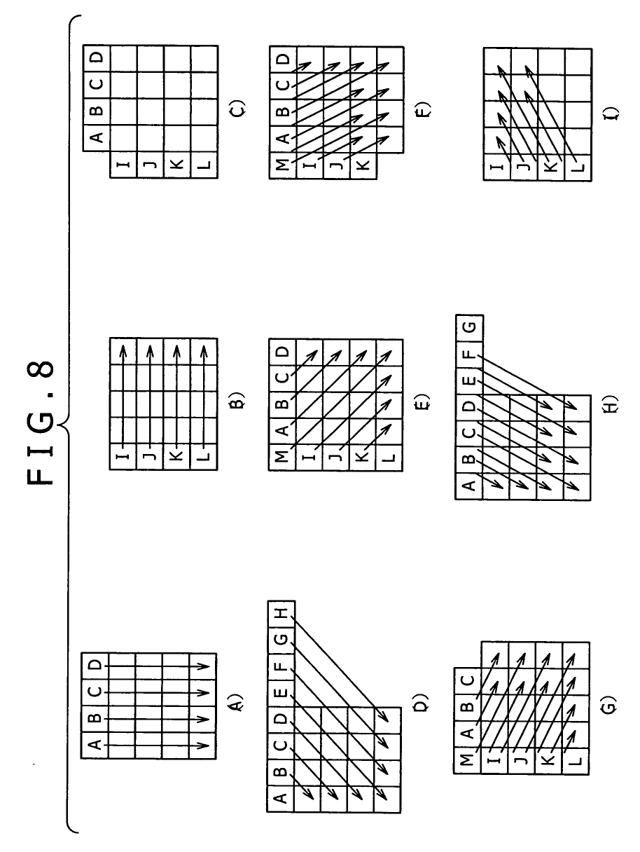

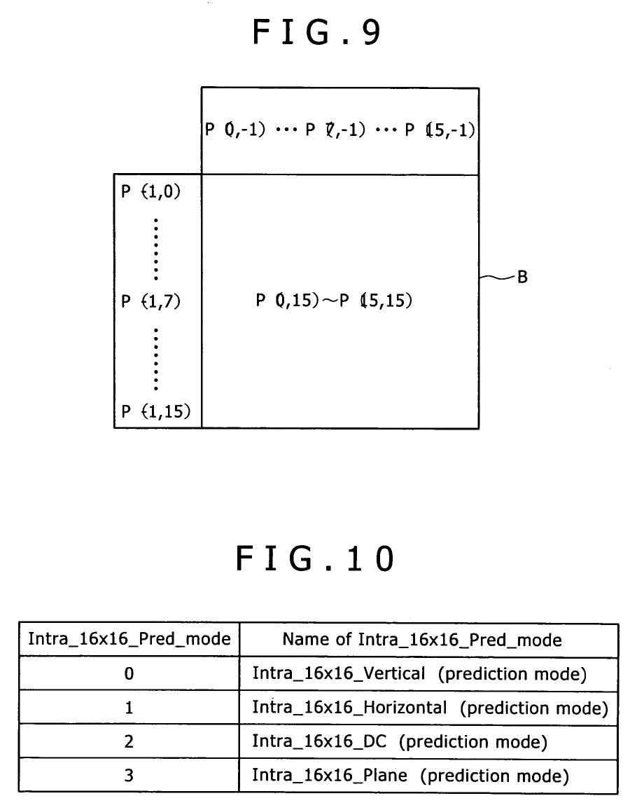

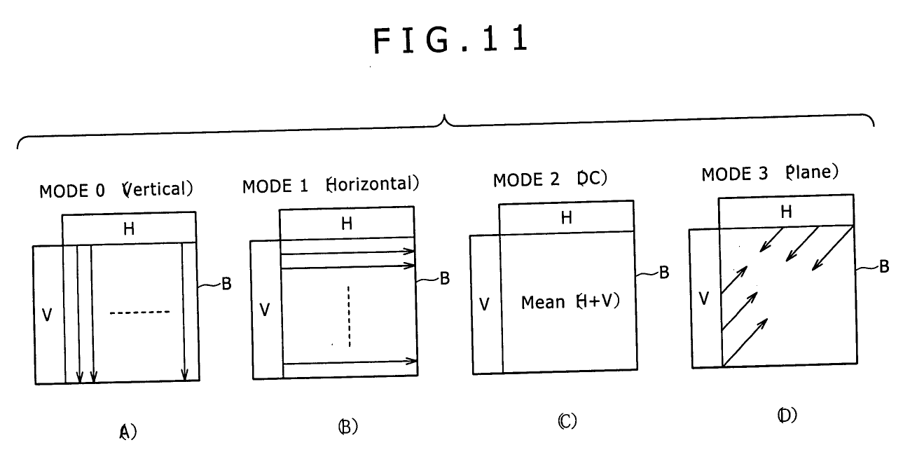

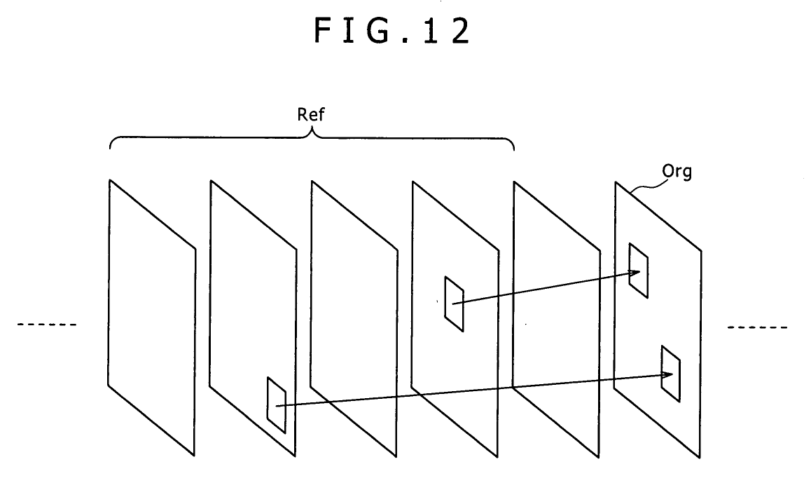

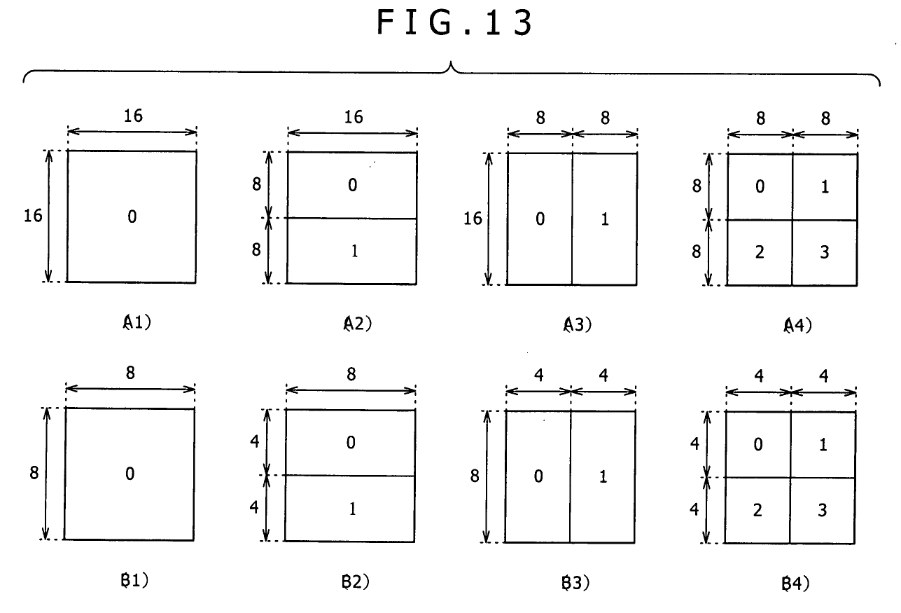

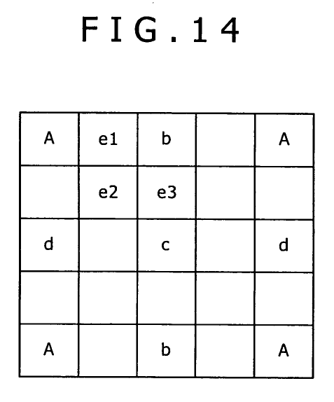

Instead of the decoded video data, the intra predictor 47 calculates predictive values expressed by the following equation according to the calculations described with reference to FIGS. 8(A) through 8(I) using the block's adjacent pixels. In the equation, Mode takes any of 0 through 8.

$$[ {Ref}_{i , j} ( Mode ) ] = [ \begin{matrix}{Ref}_{0 , 0} ( Mode ) & {Ref}_{1 , 0} ( Mode ) & {Ref}_{2 , 0} ( Mode ) & {Ref}_{3 , 0} ( Mode ) \\ {Ref}_{0 , 1} ( Mode ) & {Ref}_{1 , 1} ( Mode ) & {Ref}_{2 , 1} ( Mode ) & {Ref}_{3 , 3} ( Mode ) \\ {Ref}_{0 , 2} ( Mode ) & {Ref}_{1 , 2} ( Mode ) & {Ref}_{2 , 2} ( Mode ) & {Ref}_{3 , 3} ( Mode ) \\ {Ref}_{0 , 3} ( Mode ) & {Ref}_{1 , 3} ( Mode ) & {Ref}_{2 , 3} ( Mode ) & {Ref}_{3 , 3} ( Mode )\end{matrix} ] \qquad [ Equation 41 ]$$

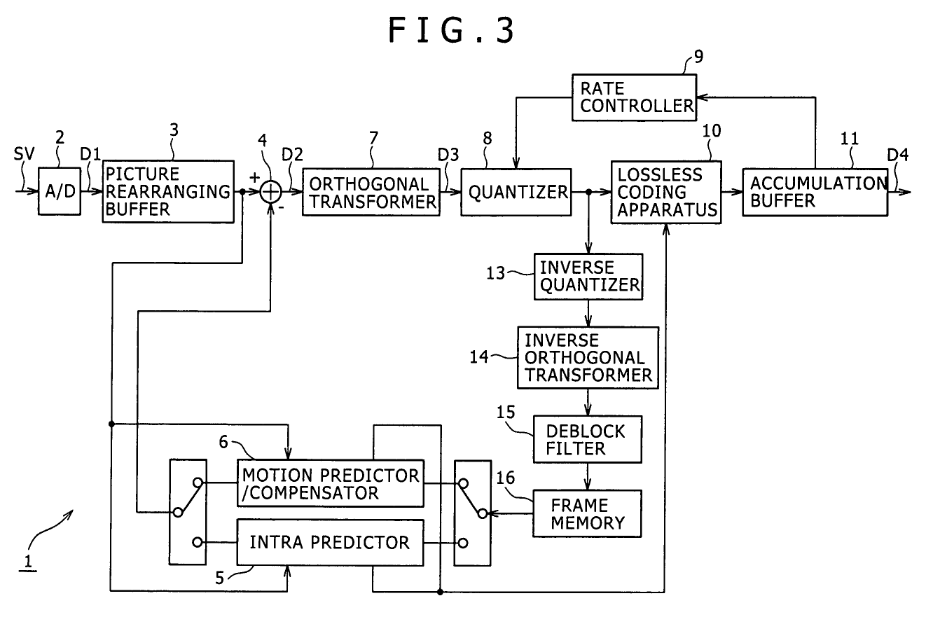

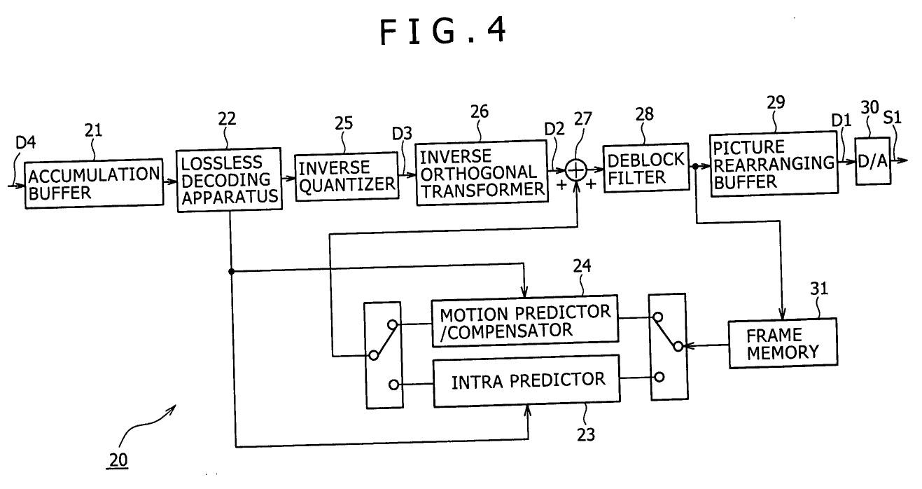

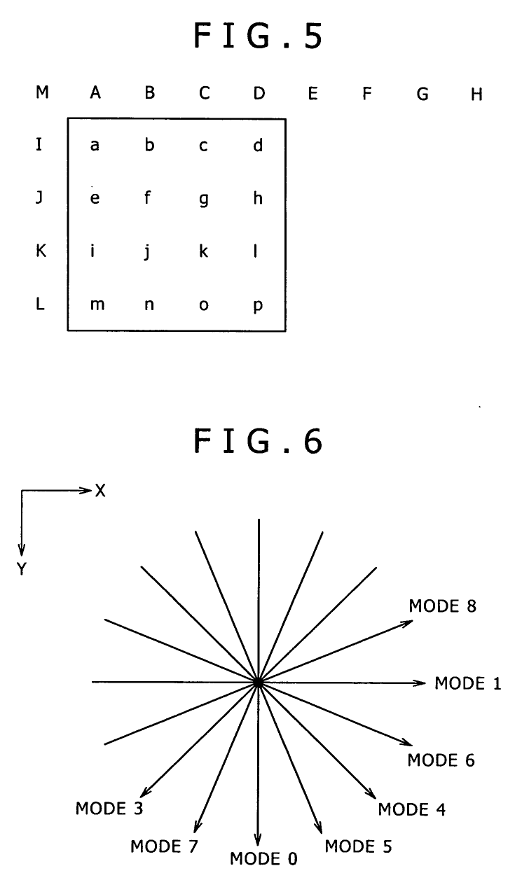

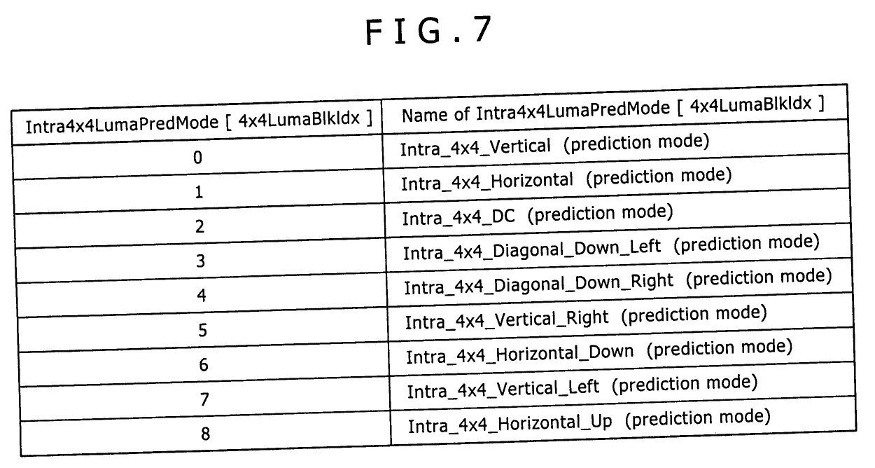

Further, the intra predictor 47 performs the calculation according to the following equation using the pixel values for the video data from the original image and the predictive values. The intra predictor 47 calculates the sum of absolute differences SAD (mode) of differential data D2 (see FIG. 3) generated in each block during the intra coding for each mode. The intra predictor 47 calculates a minimum value using the sum of absolute differences SAD (mode) for each mode. The intra predictor 47 detects modes associated with the minimum value to detect the optimum mode in the intra 4×4 prediction mode. In these calculation processes, a so-called alternate sampling technique may be used to decrease the amount of calculation by calculating only odd-numbered or even-numbered sampling points on odd-numbered or even-numbered lines, for example.

$$SAD ( Mode ) = {\sum }_{i , j = 0}^{3} \vert {Ref}_{i , j} ( Mode ) - {Org}_{i , j} \vert \qquad [ Equation 42 ]$$

The intra predictor 47 repeats this calculation for all blocks each composed of 4×4 pixels constituting the macro block of 16×16 pixels to detect optimum modes for the blocks. The intra predictor 47 performs the calculation of the following equation using the sum of absolute differences SAD (mode) (SAD (Block, Best Mode (Block)) of equation (42) for the optimum modes. The intra predictor 47 adds the sums of absolute differences SAD (mode) together for the differential data D2 concerning the optimum mode. In this manner, the intra predictor 47 sums the variables indicating residual sizes calculated from the 4×4 prediction mode to generate variable IntraSAD indicating a residual size in the macro block of 16×16 pixels. The intra predictor 47 outputs this variable IntraSAD to a difficulty calculator 49.

$$IntraSAD = {\sum }_{Block = 0}^{15} SAD ( Block , Best\_Mode ( Block ) ) \qquad [ Equation 43 ]$$

On the other hand, the inter predictor 48 performs inter prediction for video data supplied from the video memory 46. The original inter prediction is performed with reference to the decoded reference image information. The inter predictor 48 performs the inter prediction using original image's image information instead of the decoded reference image information. The inter predictor 48 omits the motion vector detection and motion compensation processes for sub-macro blocks. In this manner, the inter predictor 48 detects the reference frames and the motion vectors only for the macro block of 16×16 pixels to perform the inter prediction. The inter predictor 48 detects motions at one-pixel accuracy.

The inter predictor 48 performs the calculation of the following equation for each of the reference frames in terms of the block of 16×16 pixels in the sequentially input video data. In the equation, the reference frame's frame number Ref has the range of 0≦Ref≦Nref-1, where Nref is the number of reference frames.

$$SAD ( {mv}_{16 \times 16} ( Ref ) ) = {\sum }_{i , j = 0}^{15} \vert {Ref}_{i , j} ( {mv}_{16 \times 16} ( Ref ) ) - {Org}_{i , j} \vert \qquad [ Equation 44 ]$$

The inter predictor 48 detects a minimum value for each reference frame from the calculation result and uses the minimum value to detect 16×16 motion vector mv 16×16 (Ref) for each reference frame. In the calculation processes, a hierarchical motion retrieval may be used to detect a 16×16 motion vector from each reference frame. Alternatively, the alternate sampling technique may be used to decrease the amount of calculation. For reference, the hierarchical motion retrieval is performed to detect motion vectors as follows. For example, motion vectors are detected at a 4-pixel interval. The detected motion vectors are used to narrow the range of detecting motion vectors and redetect motion vectors. These processes are repeated sequentially. The 16×16 motion vector mv 16×16 is detected at 1-pixel accuracy in the range of ±8 pixels for motion vector retrieval.

The inter predictor 48 performs the calculation of the following equation using the calculation result SAD (mv 16×16 (Ref)) of equation (44) according to the 16×16 motion vector mv 16×16 (Ref) concerning the reference frames. The inter predictor 48 calculates an optimum reference frame and variable InterSAD indicating the residual size when the intra coding process is performed using motion vectors concerning the optimum reference frame. The inter predictor 48 outputs the variable InterSAD to the difficulty calculator 49. In equation (45), argRef signifies that Ref is varied as a variable.
InterSAD=arg_{Ref}min (SAD (mv_{16×16}(Ref ))) [Equation 45]

The difficulty calculator 49 uses variables IntraSAD and InterSAD notified from the intra predictor 47 and the inter predictor 48 to perform the calculation of the following equation and select a smaller variable. In this case, the selected variable corresponds to the optimum coding system. When the P and B pictures are targeted for prediction according to the GOP structure associated with the coding process of the coding portion 45, the difficulty calculator 49 performs the calculation of the following equation. When the I pictures are targeted for prediction, the difficulty calculator 49 cancels the calculation of the following equation and assigns the variable IntraSAD output from the intra predictor 47 to variable BD(m).
BD(m)=min (IntraSAD(m)·InterSAD(m)) [Equation 46 ]

The difficulty calculator 49 detects variable BD(m) for each macro block and performs the calculation of the following equation to sum variables BD(m) for each picture. In the equation, Ω denotes a set of all macro blocks contained in one picture.

$$X = {\sum }_{m ∈ Ω} BD ( m ) \qquad [ Equation 47 ]$$

The difficulty calculator 49 calculates difficulty parameter X indicating the difficulty of the AVC-based coding process for the video data D1 output from the video memory 46. The difficulty calculator 49 notifies the coding portion 45 of the difficulty parameter X. The complexity calculator 44 calculates the complexity parameter X by multiplying average quantization scale Q of the frames and generated code amount B together. In other words, the complexity parameter X provides information indicating the difficulty of the coding process actually detected by the coding process that generates the coded data D4. On the other hand, the complexity parameter X calculated by the difficulty calculator 49 signifies the sum of absolute differences for differential data generated during the AVC-based coding. In other words, this complexity parameter X provides information indicating the difficulty of the coding process predicted during the AVC-based coding.

The coding portion 45 allows a rate controller 45A to perform a rate control process using the parameters X output from the complexity calculator 44 and the difficulty calculator 49. Consequently, the coding portion 45 processes the video data D1 output from the video memory 46 according to the AVC-based coding and outputs the video data D1.

The coding portion 45 is configured equally to the coding apparatus 1 described with reference to FIG. 3 except the following. The video data D1 output from the video memory 46 is directly input to the picture rearranging buffer 3 without using the analog/digital converter 2. The rate controller 45A is used instead of the rate controller 9. When the sequentially input video data D1 corresponds to coded data DMPEG, the video data D1 is coded by setting I, P, and B pictures correspondingly to the settings of I, P, and B pictures in the coded data DMPEG. In this manner, the coding portion 45 is configured to perform inter coding and intra coding based on the AVC for the sequentially input video data D1 and output the coded data D4.

The rate controller 45A performs the calculation of the following equation to calculate code allocation amount Rᵢ to each picture. When the video data D1 to be coded corresponds to video signal S1, the equation uses parameter X output from the difficulty calculator 49. When the video data D1 to be coded corresponds to coded data DMPEG, the equation uses parameter X output from the complexity calculator 44. In the equation, R denotes the code allocation amount to the entire uncoded frame (0≦i≦N-1).

$${R}_{i} = R \cdot \frac{{X}_{i}^{\frac{1}{2}}}{{\sum }_{i} {X}_{i}^{\frac{1}{2}}} \qquad [ Equation 48 ]$$

The rate controller 45A calculates an initial value for the code allocation amount Rᵢ at the beginning of each GOP. Each time one-frame coding terminates, the rate controller 45A detects the actual generated code amount according to the data amount in the accumulation buffer 11 and corrects the code allocation amount R for all the uncoded frames. The rate controller 45A calculates the code allocation amount Rᵢ to the next frame. The rate controller 45A repeats these processes for each of the GOPs. In each frame, the rate controller 45A uses the actually generated code amount to sequentially correct code allocation amounts for the macro blocks detected from the code allocation amounts for the frames. The rate controller 45A uses the detected code allocation amounts to set the quantization scale of the quantizer 8. In these processes, the rate controller 45A corrects the quantization scale of the quantizer 8 according to activities.

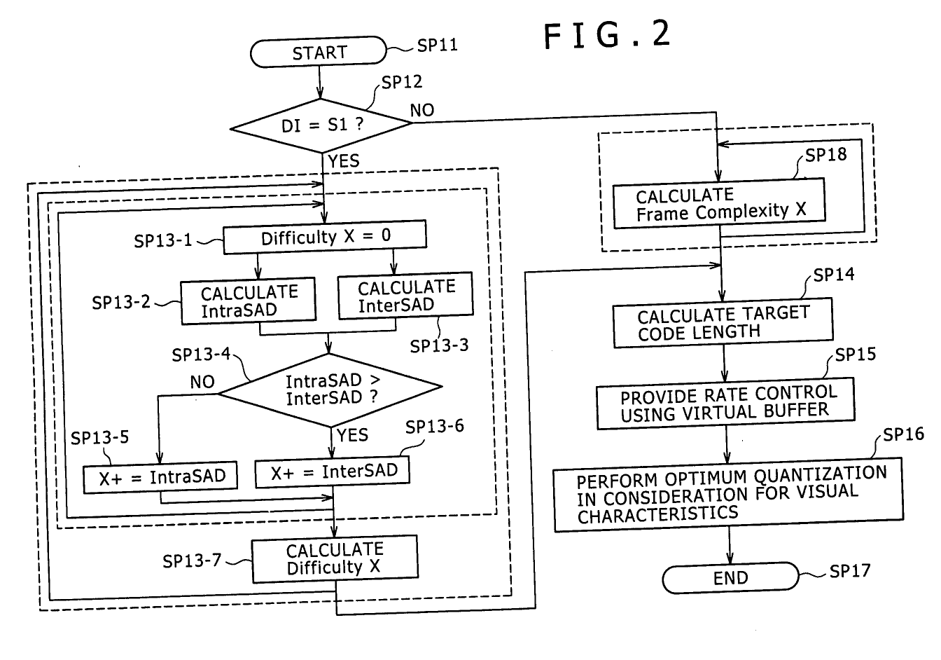

FIG. 2 is a flowchart showing a rate control process by the rate controller 45A as well as a process associated with the complexity calculator 44 and the difficulty calculator 49. When the process starts, the rate controller 45A proceeds to Step SP12 from Step to determine whether or not the video data D1 to be processed corresponds to an analog video signal S1. When the result is affirmative, the rate controller 45A proceeds to Step SP13 to obtain parameter X from the difficulty calculator 49.

At Step SP13-1 of Step SP13, the difficulty calculator 49 initializes parameter X to value 0. At Steps SP13-2 and SP13-3, the intra predictor 47 and the inter predictor 48 calculate variables IntraSAD and InterSAD, respectively. At Step SP13-4, the difficulty calculator 49 compares variables IntraSAD with InterSAD.

When the value of variable IntraSAD from the intra predictor 47 is smaller, variable IntraSAD from the intra predictor 47 is selected at Step SP13-5. When the value of variable InterSAD from the intra predictor 48 is smaller, variable InterSAD from the intra predictor 48 is selected at Step SP13-6. In this manner, the difficulty calculator 49 detects variable SAD for one macro block. The difficulty calculator 49 repeats this process for one frame. At Step SP13-7, the difficulty calculator 49 accumulates the variables to detect parameter X for one frame constituting the GOP. The detection of parameter X is repeated for the number of times equivalent to one GOP.

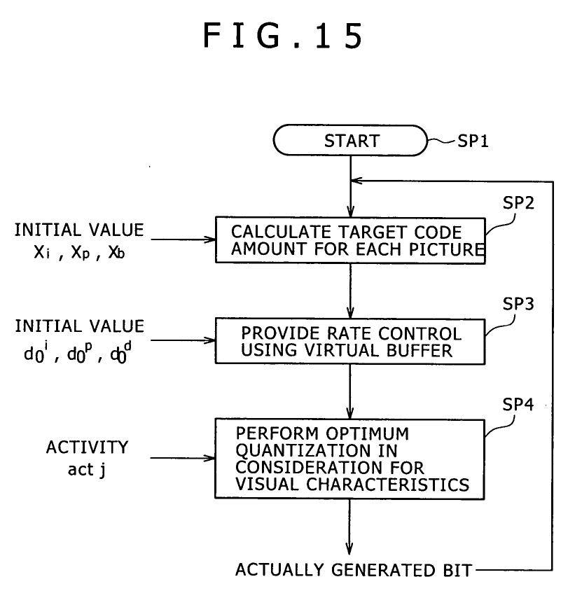

After obtaining parameter X for one GOP from the difficulty calculator 49, the rate controller 45A proceeds to Step SP14 from Step SP13 to calculate the code allocation amount for one picture using the calculation of equation (48). At Step SP15, the rate controller 45A determines the quantization scale of the quantizer 8 similarly to Step SP3 in FIG. 15 as mentioned above. At Step SP16, the rate controller 45A corrects the quantization scale of the quantizer 8 according to activities similarly to Step SP4 in FIG. 15 as mentioned above. The rate controller 45A proceeds to Step SP17 to terminate the process. The rate controller 45A repeats this process in units of GOPs to perform the rate control process.

When the result at Step SP12 is negative, the rate controller 45A proceeds to Step SP18 from Step SP12 to obtain parameter X for one GOP from the complexity calculator 44. At Step SP14, the rate controller 45A uses parameter X obtained from the complexity calculator 44 to calculate the code allocation amount and perform the rate control process. At Step SP18, the complexity calculator 44 is configured to repeat the calculation of variable X in units of pictures.

(2) Operations of the Embodiment

According to the above-mentioned construction, let us consider coding the analog video signal S1 in the coding apparatus 41 (FIG. 1). In this case, the analog/digital converter 42 converts the video signal S1 into the video data D1. The video data D1 is then input to the coding portion 45 via the video memory 46. In the coding portion 45, the picture rearranging buffer 3 rearranges the order of frames in the video data D1 (see FIG. 3) according to the GOP structure for the coding process. The video data D1 is then input to the intra predictor 5 and the motion predictor/compensator 6. According to pictures, an optimum prediction mode is selected from a plurality of intra prediction modes and inter prediction modes. The subtractor 4 subtracts a predictive value in the selected prediction mode from the video data D1 to generate the differential data D2. The video data D1 is reduced in terms of the data amount through the effective use of the correlation between the contiguous frames and the horizontal and vertical correlations. The video data D1 with the reduced data amount results in the differential data D2. The differential data D2 is further reduced in terms of the data amount through the orthogonal transformation, quantization, and variable length coding processes to generate the coded data D4. In this manner, the video signal S1 is processed according to the intra coding and the inter coding and then is recorded on a recording medium.

In the sequence of processes, the video data D1 is input to the intra predictor 47 and the inter predictor 48 (FIG. 1) for at least one GOP prior to the process in the coding portion 45. The intra predictor 47 and the inter predictor 48 select an optimum prediction mode for the intra prediction and the inter prediction, respectively. Using the sum of absolute differences for the differential data D2, the intra predictor 47 and the inter predictor 48 calculate variables IntraSAD and InterSAD indicating sizes of the differential data D2 generated in the optimum prediction mode. The difficulty calculator 49 compares the variables IntraSAD with InterSAD to detect an optimum prediction mode according to the intra prediction and the inter prediction. The difficulty calculator 49 detects variable BD(m) indicating the size of the differential data D2 generated in the optimum prediction mode.

In the video data D1, the variable BD(m) is calculated in units of pictures to generate variable X. Using the variable X, the rate controller 45A distributes the data amount, to be allocated to one GOP, among the pictures to calculate the target code amount for each picture. The rate control process is performed based on the target code amount.

In this manner, the video data D1 is coded under rate control according to the feed-forward control using the variable X detected in advance for one GOP. As a result, the video data D1 can be coded by appropriately distributing the code amount to the pictures and by ensuring high image quality.

The target code amount for each picture can be calculated by distributing the data amount to be allocated to one GOP using the picture-based variable X that indicates the size of the differential data D2. The target code amount can be used to perform the rate control process for integration with decoding means. Even when there may be a case of converting the format of coded data that is coded by a similar coding method, the rate control is available by efficiently using the information about the coded data. As a result, the overall construction can be simplified.

The coding apparatus 41 may convert the format of MPEG2-based coded data DMPEG into the AVC-based coded data D4. In this case, the decoding apparatus 43 decodes the MPEG2-based coded data DMPEG to convert it into the video data D12. The video data D12 is input to the coding portion 45 and is coded into the AVC-based coded data D4.

In the sequence of processes, the coded data DMPEG allows quantization scale Q and data amount B to be detected for each of the macro blocks. The complexity calculator 44 sums the detection result to detect value X resulting from multiplying average quantization scale Q by data amount B in units of frames. The multiplied value X denotes the complexity of the coding process. When coding the video data D12 according to the coded data DMPEG, the coding apparatus 41 uses variable X output from the complexity calculator 44 instead of variable X output from the difficulty calculator 49. The data amount to be allocated to one GOP is distributed among the pictures to calculate the target code amount for each picture. The rate control process is performed based on the target code amount.

In this manner, the coding apparatus 41 can provide the rate control for the coded data DMPEG effectively using various information detected in the decoding process. This makes it possible to simplify the construction and ensure the functions as the image conversion apparatus.

Also in this case, the rate control is provided in the end using MPEG2-based coding results in the past. The rate control according to the feed-forward control can be used to code the video data D12. As a result, the video data D12 can be coded by appropriately distributing the code amount to the pictures and by ensuring high image quality better than the rate control according to the feedback control by means of intra prediction and inter prediction.

In this manner, the intra predictor 47 and the inter predictor 48 are used to detect variable X. The coding apparatus 41 can allow the intra predictor 47 and the inter predictor 48 to perform intra prediction and inter prediction in much simpler construction than that for intra prediction and inter prediction in the coding portion 45. As a whole, the simple construction can be used to code the video data D1.

That is, the coding portion 45 provides the intra prediction mode for intra prediction. This mode generates predictive values to generate the differential data D2 for two or more types of blocks having different sizes by means of a plurality of techniques in units of blocks. By contrast, the intra predictor 47 selects an optimum prediction mode for the smallest block out of two or more types of blocks and detects the variable IntraSAD for intra prediction. This makes it possible to detect the optimum prediction mode and the variable IntraSAD for intra prediction by means of simple processes at the practically sufficient accuracy.

Specifically, the coding apparatus 41 uses two or more types of blocks, i.e., blocks of 4×4 and 16×16 pixels. The intra predictor 47 processes video data only in the 4×4 prediction mode for blocks of 4×4 pixels. This can simplify the process.

The coding portion 45 provides the process for intra prediction to select an optimum prediction mode with reference to the video data resulting from decoded output data. The intra predictor 47 selects an optimum prediction mode based on the video data D1 concerning a so-called original image. In this respect, the video data D1 is output from the video memory 46 in advance for one GOP. According to the construction, the feed-forward control is used to provide rate control. This makes it possible to omit the construction of the decoding means, memory to store decoding results from the decoding means, and the like. The overall construction can be simplified while ensuring the practically sufficient accuracy.

The coding portion 45 provides the inter prediction mode for inter prediction. This mode generates predictive values to generate the differential data D2 for two or more types of blocks having different sizes by means of a plurality of techniques in units of blocks. By contrast, the inter predictor 48 selects an optimum prediction mode for the largest block out of two or more types of blocks and detects the variable InterSAD for inter prediction. This also makes it possible to detect the optimum prediction mode and the variable InterSAD for inter prediction by means of simple processes at the practically sufficient accuracy.

Specifically, the coding apparatus 41 uses two or more types of blocks, i.e., sub-macro blocks of 4×4, 4×8, 8×4, 8×8, 8×16, and 16×8 pixels and blocks or macro blocks of 16×16 pixels. The inter predictor 48 processes video data for only macro blocks of 16×16 pixels. This can simplify the process.

The differently sized blocks allow the intra predictor 47 and the inter predictor 48 to detect variables. The intra predictor 47 sums and outputs variables for the intra prediction so as to correspond to the block size for the inter predictor 48. The purpose of simplifying the construction provides different sizes of blocks for the processes. This makes it possible to detect an optimum prediction mode according to the corresponding variable.

The coding portion 45 uses the inter prediction mode for inter prediction to detect motion vectors from a plurality of reference frames at the accuracy of ¼ pixels smaller than one pixel. By contrast, the inter predictor 48 detects motion vectors at one-pixel accuracy. In this manner, the simple process can be used to detect an optimum prediction mode at the practically sufficient accuracy and detect the variable InterSAD for inter prediction.

(3) Effects of the Embodiment

The above-mentioned construction makes it possible to detect optimum prediction modes for intra prediction and inter prediction prior to the coding process. The construction also enables detection of a variable indicating the differential data size according to the detected optimum prediction mode. The variable is used to set the target code amount for each picture. In this manner, the overall construction can be simplified when the coding apparatus may be configured to function as a decoding apparatus and an image conversion apparatus.

That is, video data is processed according to orthogonal transformation, quantization, and variable length coding to generate coded data DMPEG. When the coded data DMPEG is processed, its quantization scale is multiplied by the data amount to yield multiplied value X. Using the multiplied value X, the data amount to be allocated to one GOP is distributed to pictures and perform the rate-controlled process. In this manner, the construction can be simplified to ensure the function as the image conversion apparatus.

A plurality of intra prediction modes for coding may generate predictive values for two or more types of blocks having different sizes by means of a plurality of techniques in units of blocks. In this case, the intra predictor 47 as intra prediction means selects an optimum prediction mode for the smallest block out of two or more types of blocks and detects a variable for intra prediction. This makes it possible to detect the optimum prediction mode and the variable for intra prediction by means of simple processes at the practically sufficient accuracy.

More specifically, the two or more types of blocks may include blocks of 4×4 and 16×16 pixels. The intra predictor means can process video data only in the 4×4 prediction mode for blocks of 4×4 pixels. This can simplify the process.

Coding means may select an optimum prediction mode with reference to decoded video data. In such case, the intra prediction means selects an optimum prediction mode with reference to original video data. The overall construction can be simplified while ensuring the practically sufficient accuracy.

A plurality of inter prediction modes generate predictive values for two or more types of blocks having different sizes by means of a plurality of techniques in units of blocks. By contrast, the inter predictor 48 as inter prediction means selects an optimum prediction mode for the largest block out of two or more types of blocks and detects a variable for inter prediction. This makes it possible to detect the optimum prediction mode and the variable for inter prediction by means of simple processes at the practically sufficient accuracy.

Specifically, the two or more types of blocks include blocks of 4×4, 4×8, 8×4, 8×8, 8×16, 16×8, and 16×16 pixels. The inter prediction means processes video data for only macro blocks of 16×16 pixels. This can simplify the process.

Variables for the intra prediction are summed and output so as to correspond to the block size for the inter prediction means. The purpose of simplifying the construction provides different sizes of blocks for the processes. This makes it possible to detect an optimum prediction mode according to the corresponding variable.

The coding means provides a plurality of inter prediction modes. These modes use motion vectors detected from a plurality of reference frames at the accuracy of pixels smaller than one pixel and generate predictive values by performing motion compensation for the corresponding reference frame. By contrast, the inter prediction means detects motion vectors at the accuracy of one pixel to detect an optimum prediction mode. In this manner, the simple process can be used to detect an optimum prediction mode at the practically sufficient accuracy and detect the variable for inter prediction.

[Embodiment 2]

According to this embodiment, a computer executes a coding program. In this manner, the computer provides function blocks corresponding to the blocks of the above-mentioned coding apparatus 41 with reference to embodiment 1. The computer performs processes equivalent to those of the coding apparatus 41. The coding program may be provided by being preinstalled in computers. Further, the coding program may be provided by being downloaded via networks such as the Internet. Alternatively, the coding program may be provided by being recorded on recording media. There may be available various recording media such as optical disks, magnetic optical disks, and the like.

Like this embodiment, a computer may execute the processing program to construct the function blocks similar to those of the coding apparatus 41 according to embodiment 1 for coding. Also in this case, embodiment 2 can provide the effects similar to those for embodiment 1.

[Embodiment 3]

In the above-mentioned embodiments, there has been described the case of detecting variables concerning intra prediction and inter prediction using the sum of absolute differences in differential data. However, the present invention is not limited thereto. Various parameters can be widely applied as needed such as the sum of squares of differential data, for example, in stead of the sum of absolute differences in differential data.

In the above-mentioned embodiments, there has been described the case of simplifying processes in the intra prediction means and the inter prediction means for intra prediction and inter prediction in the coding means in terms of the accuracy associated with the reference image information and the motion compensation and in terms of the types of blocks associated with the prediction mode. However, the present invention is not limited thereto. When the practically sufficient throughput can be ensured, the intra prediction means and the inter prediction means may be used to perform the same processes as the intra prediction and the inter prediction in the coding means.

In the above-mentioned embodiments, there has been described the case of coding analog video signals and MPEG2-based coded data into AVC-based coded data. However, the present invention is not limited thereto. The present invention can be widely applied to cases of coding various video data and coded data into AVC-based coded data and into coded data similar to the AVC.

In the above-mentioned embodiments, there has been described the case of applying the present invention to the recording apparatus. However, the present invention is not limited thereto and can be widely applied to transmission of video data, for example.

For example, the present invention can be applied to transmission of motion pictures by means of satellite broadcasting, cable television, Internet, cellular phones, and the like, recording of motion pictures on recording media such as optical disks, magnetic optical disks, flash memory, and the like.

It should be understood by those skilled in the art that various modifications, combinations, sub-combinations and alterations may occur depending on design requirements and other factors insofar as they are within the scope of the appended claims or the equivalents thereof.

What is claimed is:

1. A coding apparatus which uses coding means to select an optimum prediction mode out of a plurality of intra prediction modes and inter prediction modes, generate differential data by subtracting a predictive value according to said selected prediction mode from video data, perform orthogonal transformation, quantization, and variable length coding processes for said differential data, and encode said video data according to intra coding and inter coding, said coding apparatus comprising:
intra prediction means for selecting an optimum prediction mode using said video data in advance for at least one GOP prior to coding by said coding means and detecting an intra prediction variable indicating a size of differential data in said optimum prediction mode;
inter prediction means for selecting an optimum prediction mode using said video data in advance for at least one GOP prior to coding by said coding means and detecting an inter prediction variable indicating a size of differential data in said optimum prediction mode;
difficulty calculation means for comparing a variable for said intra prediction with a variable for said inter prediction and detecting a variable indicating a size of differential data in an optimum prediction mode; and
rate control means for distributing a data amount to be allocated to one GOP among pictures based on a variable indicating a size of said differential data to calculate a target code amount of each picture and providing rate control for a coding process by said coding means based on said target code amount.

2. The coding apparatus according to claim 1 having:
decoding means for receiving coded data generated from video data through orthogonal transformation, quantization, and variable length coding processes and decoding said video data; and
complexity detection means for detecting a multiplied value between a quantization scale for said quantization process concerning said coded data and a data amount of said coded data in units of pictures for video data output from said decoding means,
wherein, when said coding means encodes video data output from said decoding means,
said rate control means does not distribute a data amount to be allocated to one GOP among pictures based on a variable indicating a size of said differential data to calculate a target code amount of each picture, nor provide rate control for a coding process by said coding means based on said target code amount, but distribute a data amount to be allocated to one GOP among pictures based on said multiplied value to calculate a target code amount of each picture and provide rate control for a coding process by said coding means based on said target code amount.

3. The coding apparatus according to claim 1,
wherein said plurality of intra prediction modes generate said predictive value for two or more types of blocks having different sizes by means of a plurality of techniques in units of blocks; and
wherein said intra prediction means selects said optimum prediction mode for the smallest block out of said two or more types of blocks and detects a variable for said intra prediction.

4. The coding apparatus according to claim 3,
wherein said two or more types of blocks include blocks of 4×4 and 16×16 pixels.

5. The coding apparatus according to claim 1,
wherein said coding means selects said optimum prediction mode with reference to decoded video data generated by decoding data output from said coding means; and
wherein said intra prediction means selects said optimum prediction mode with reference to said video data in advance for at least one GOP prior to coding by said coding means.

6. The coding apparatus according to claim 1,
wherein said plurality of inter prediction modes generate said predictive value for two or more types of blocks having different sizes by means of a plurality of techniques in units of blocks; and
wherein said inter prediction means selects said optimum prediction mode for the largest block out of said two or more types of blocks and detects a variable for said inter prediction.

7. The coding apparatus according to claim 6,
wherein said two or more types of blocks include blocks of 4×4, 4×8, 8×4, 8×8, 8×16, 16×8, and 16×16 pixels.

8. The coding apparatus according to claim 3,
wherein said inter prediction means selects said optimum prediction mode for the largest block out of said two or more types of blocks and detects a variable for said inter prediction; and
wherein said intra prediction means sums and outputs variables for said intra prediction so as to correspond to a block size for said inter prediction means.

9. The coding apparatus according to claim 1,
wherein said intra prediction means selects a prediction mode corresponding to the smallest size of said differential data obtained according to said plurality prediction modes and defines the selected prediction mode as said optimum prediction mode.

10. The coding apparatus according to claim 1,
wherein said inter prediction means selects a prediction mode corresponding to the smallest size of said differential data obtained according to said plurality prediction modes and defines the selected prediction mode as said optimum prediction mode.

11. The coding apparatus according to claim 1,
wherein said coding means provides a plurality of inter prediction modes which use motion vectors detected from a plurality of reference frames at an accuracy of pixels smaller than one pixel and generate predictive values by performing motion compensation for a corresponding reference frame; and
wherein said inter prediction means detects motion vectors at an accuracy of one pixel to detect an optimum prediction mode.

12. A coding method which uses coding means to select an optimum prediction mode out of a plurality of intra prediction modes and inter prediction modes, generate differential data by subtracting a predictive value according to said selected prediction mode from video data, perform orthogonal transformation, quantization, and variable length coding processes for said differential data, and encode said video data according to intra coding and inter coding, said coding method comprising the steps of:
selecting an optimum prediction mode using said video data in advance for at least one GOP prior to coding by said coding means and detecting an intra prediction variable indicating a size of differential data in said optimum prediction mode;
selecting an optimum prediction mode using said video data in advance for at least one GOP prior to coding by said coding means and detecting an inter prediction variable indicating a size of differential data in said optimum prediction mode;
comparing a variable for said intra prediction with a variable for said inter prediction and detecting a variable indicating a size of differential data in an optimum prediction mode; and
distributing a data amount to be allocated to one GOP among pictures based on a variable indicating a size of said differential data to calculate a target code amount of each picture and providing rate control for a coding process by said coding means based on said target code amount.

13. A coding method program performed by calculation means to control operations of coding means,
wherein said coding means selects an optimum prediction mode out of a plurality of intra prediction modes and inter prediction modes, generates differential data by subtracting a predictive value according to said selected prediction mode from video data, performs orthogonal transformation, quantization, and variable length coding processes for said differential data, and encodes said video data according to intra coding and inter coding; and
wherein said coding method program comprises the steps of:
selecting an optimum prediction mode using said video data in advance for at least one GOP prior to coding by said coding means and detecting an intra prediction variable indicating a size of differential data in said optimum prediction mode;
selecting an optimum prediction mode using said video data in advance for at least one GOP prior to coding by said coding means and detecting an inter prediction variable indicating a size of differential data in said optimum prediction mode;
comparing a variable for said intra prediction with a variable for said inter prediction and detecting a variable indicating a size of differential data in an optimum prediction mode; and
distributing a data amount to be allocated to one GOP among pictures based on a variable indicating a size of said differential data to calculate a target code amount of each picture and providing rate control for a coding process by said coding means based on said target code amount.

14. A recording medium for recording a coding method program performed by calculation means to control operations of coding means,
wherein said coding means selects an optimum prediction mode out of a plurality of intra prediction modes and inter prediction modes, generates differential data by subtracting a predictive value according to said selected prediction mode from video data, performs orthogonal transformation, quantization, and variable length coding processes for said differential data, and encodes said video data according to intra coding and inter coding; and
wherein said coding method program comprises the steps of:
selecting an optimum prediction mode using said video data in advance for at least one GOP prior to coding by said coding means and detecting an intra prediction variable indicating a size of differential data in said optimum prediction mode;
selecting an optimum prediction mode using said video data in advance for at least one GOP prior to coding by said coding means and detecting an inter prediction variable indicating a size of differential data in said optimum prediction mode;
comparing a variable for said intra prediction with a variable for said inter prediction and detecting a variable indicating a size of differential data in an optimum prediction mode; and
distributing a data amount to be allocated to one GOP among pictures based on a variable indicating a size of said differential data to calculate a target code amount of each picture and providing rate control for a coding process by said coding means based on said target code amount.

15. A coding apparatus which uses coding unit to select an optimum prediction mode out of a plurality of intra prediction modes and inter prediction modes, generate differential data by subtracting a predictive value according to said selected prediction mode from video data, perform orthogonal transformation, quantization, and variable length coding processes for said differential data, and encode said video data according to intra coding and inter coding, said coding apparatus comprising:
intra prediction unit configured to select an optimum prediction mode using said video data in advance for at least one GOP prior to coding by said coding unit and detect an intra prediction variable indicating a size of differential data in said optimum prediction mode;
inter prediction unit configured to select an optimum prediction mode using said video data in advance for at least one GOP prior to coding by said coding unit and detect an inter prediction variable indicating a size of differential data in said optimum prediction mode;
difficulty calculation unit configured to compare a variable for said intra prediction with a variable for said inter prediction and detect a variable indicating a size of differential data in an optimum prediction mode; and
rate control unit configured to distribute a data amount to be allocated to one GOP among pictures based on a variable indicating a size of said differential data to calculate a target code amount of each picture and provide rate control for a coding process by said coding unit based on said target code amount.
